(19) United States
(12) Patent Application Publication
(10) Pub. No.: US 2026/0070126 A1
(43) Pub. Date: Mar. 12, 2026

(54) DEVICE AND METHOD FOR MONITORING THE STATE OF A PROTECTIVE GLASS OF A MANUFACTURING SYSTEM AND MANUFACTURING SYSTEM FOR AN ADDITIVE MANUFACTURING METHOD

(71) Applicant: DMG MORI ADDITIVE GmbH, Bielefeld (DE)

(72) Inventors: Leroy ROONEY, Emsdetten (DE); Hermann STURZEBECHER, Osnabrück (DE); Talu ÜNAL-SAEWE, Bielefeld (DE)

(21) Appl. No.: 18/995,125

(22) PCT Filed: Dec. 11, 2023
(86) PCT No.: PCT/EP2023/085129

§ 371 Date: Jan. 15, 2025

(30) Foreign Application Priority Data
Jul. 17, 2023 (DE) 10 2023 118 856.9

(51) Int. Cl. B22F 10/28; B22F 10/85; B22F 12/42; B22F 12/49; B22F 12/90; B33Y 10/00; B33Y 30/00; B33Y 50/02

(52) U.S. Cl. CPC B22F 10/28; B22F 10/85; B22F 12/42; B22F 12/49; B22F 12/90; B33Y 10/00; B33Y 30/00; B33Y 50/02

(57) ABSTRACT

The present invention relates to a manufacturing system 1 for manufacturing a workpiece 26 by exposing powder material and/or a workpiece element. The manufacturing system 1 comprises at least one light source 4 for irradiating the powder material 18 and/or workpiece element provided in a processing chamber 12; a light path 14 generated by the light source 4 which extends through a protective glass 10 into the processing chamber 12 of the manufacturing system 1, wherein the protective glass 10 is provided for protection against damage and/or contamination. At least one exposure device L1-L9 is provided for exposing an object plane 30 associated with the protective glass 10 of the manufacturing system 1. The exposure device L1-L9 encloses the protective glass 10 at least partially, preferably completely, and comprises a plurality of similar light-emitting diodes, LEDs for homogeneous illumination.

The present invention relates to an automatable manufacturing system based on optical interaction, in particular a manufacturing system for selective laser melting (SLM), and an integratable device, in which the soiling, damage and/or ageing state of one or more protective glasses integrated in the manufacturing system is determined by optical detection and analysis of an object plane assigned to the manufacturing system. Furthermore, the present invention relates to a manufacturing system for automated manufacturing of workpieces by irradiating a material to be processed, which makes it possible to assess the state and/or the service life of the protective glass with the aid of signal exchanges between the integrated analysis device.

### BACKGROUND OF THE INVENTION

On account of increasingly complex work processes and the resulting requirement to be able to manufacture as precisely as possible, in an automated manner and over a large area, the production and processing of workpieces on the basis of optical interaction processes has become established.

Generic manufacturing systems known from the prior art and based on optical interaction, such as for instance laser-induced manufacturing systems and/or manufacturing systems based on additive production steps, such as for instance selective laser melting, in this case usually comprise one or more high-intensity light sources, which are coupled to a plurality of finely adjusted optical elements (lenses, mirrors, filters etc.) that can be actuated in an automated manner via a computer system and thus make it possible to act thermally on a desired workpiece or a desired material by generating a condensed light beam that is focused onto a specific production point. By way of example, a manufacturing system according to the selective laser melting method has at least one laser light source, which, by means of software-supported optics, can focus a bundled laser beam onto pulverulent layers of materials to be processed and can thus generate an extremely effective, three-dimensional manufacturing process by local fusions that can be connected to one another in layers.

Despite continuous development of such manufacturing systems, however, the problem continues to arise in most of such systems that, on account of contamination or processing residues arising during the manufacturing process, the components required for forwarding the optical processing beam can be contaminated or even damaged, as a result of which a reduction in the exposure precision and consequently a reduction in the quality of the workpiece to be created occurs during ongoing manufacturing processes. Thus, such manufacturing systems have for example at least one (for example light-transmissive) protective glass, which is positioned between the light-guiding optics or the light source and a processing point used for manufacturing the workpiece in order to protect the optical elements and can thus inevitably come into contact with the process emissions mentioned. In this case, however, contamination or damage to the protective glass involves a large number of problems: firstly, turbidities of the protective glass can arise, which adversely influence the light path, such that the intensity of the processing light beam decreases, for example. In addition, however, it is also possible that individual light scatterings occurring at contamination or damage areas can lead to a displacement of the beam profile, as a result of which not only quality fluctuations within the production line can be identified, but also the energy of the light source deflected or absorbed in this way generates further damage (for example fusions, fractures or cracks) within the protective glass. Accordingly, it is critical for optical manufacturing systems to develop as precise an analysis as possible for identifying any abnormal states, such as for example contamination and damage states, which is capable both of making it possible to assess the degree of contamination or damage of a protective glass implemented in the manufacturing system already within existing manufacturing processes and of integrating this assessment mechanism into the manufacturing system as noninvasively and efficiently as possible.

DE 102014203798 relates to a method for monitoring the contamination and/or damage state on a protective glass of a laser processing head fastened to a robot, for which purpose the robot moves the laser processing head into the field of view of a camera device installed in a stationary manner.

However, known methods and devices have the problem that, on account of the merely passive measurement techniques (the methods measure the effects emanating from “contaminations”, but not the contamination itself), it is not possible to make a direct statement about the degree of contamination of a used protective glass, but merely optical properties of the protective glass that can be influenced and thus also by other sources (bending, aging processes within the material) are identified. Furthermore, known devices are neither capable of localizing contamination accumulations in a spatially resolved manner (since the measured scattered light can potentially arise from any region of the exposed area) nor of being meaningfully integrated into already existing manufacturing systems, since any scattered light measurements cause a system geometry oriented specifically for this purpose.

It is an object of the present invention to provide an optimised manufacturing system for additive manufacturing, with which an improved production quality can be achieved. In addition, it is an object to provide an integratable analysis device, with which a status of the manufacturing system can be monitored efficiently. It is a further object to eliminate the mentioned problems of the state of the art and in particular to provide an analysis device for detecting states, in particular soiling, damage and/or aging states, on one or more protective glasses of a manufacturing system based on optical interactions, which analysis device itself can detect local state changes, such as individual soiling and/or damage structures, and thus can make the evaluation of degrees of soiling, damage or aging even more precise and effective. In addition, it is an object of the present invention to provide an analysis device to be integrated as simply as possible into the process sequence of existing manufacturing systems, which analysis device both uses the additional information obtained by the state localization for determining predefined evaluation parameters and can also use said additional information for monitoring and predicting possible cleaning and/or replacement times of a protective glass.

### DETAILED DESCRIPTION OF THE INVENTION

To achieve the above-mentioned object, the features of the independent claims are proposed. The dependent claims relate to preferred exemplary embodiments of the present invention.

A manufacturing system for manufacturing a workpiece by exposing powder material and/or a workpiece element can comprise at least one light source for irradiating the powder material and/or workpiece element provided in a processing chamber. In addition, a light path generated by the light source which extends through a protective glass into the processing chamber of the manufacturing system can be present. The protective glass can be provided for protection against damage and/or contamination. In addition, at least one exposure device (integrated into the manufacturing system) can be provided for (direct, lateral coupling) exposure of an object plane associated with the protective glass of the manufacturing system. The exposure device can enclose the protective glass at least partially, preferably completely, laterally (in particular, the exposure device can be arranged on at least two sides, in particular opposite sides, of the protective glass) and a plurality of (in particular uniformly spaced and/or similar) light-emitting elements such as light-emitting diodes, LEDs, can be provided for continuous (and preferably only activated at predefined time intervals) homogeneous exposure of the protective glass and in particular of the object plane. (Preferably, the LEDs are arranged uniformly on a side surface of the protective glass for this purpose, so that they emit light beams extending in parallel for homogeneous illumination of the protective glass.) In the case of the protective glass, the coupled-in light is guided through (or along) the entire protective glass. If a contamination or a defect is encountered, scattered light occurs at the defect.

The exposed object plane can be assessed, for example, by manual, direct optical detection (e.g. by the system operator), and/or at least one optical sensor can be provided for automated (electronic) detection of the exposed object plane. Particularly advantageous homogeneous illumination can be achieved by this arrangement, so that in particular contamination and damage states of the protective glass can be determined effectively and accurately. Uniform illumination without shadow formation and with uniformly intense luminosity is achieved.

The LEDs (or LED arrays) can preferably be arranged laterally on the protective glass for direct exposure of the object plane. Advantageously, the LEDs are in contact with a side surface of the protective glass and/or the emission direction of the LEDs is oriented toward the protective glass. (For example, the protective glass is arranged horizontally and the emission direction of the LEDs is also oriented horizontally.) A particularly effective determination of the contamination and damage states of the protective glass could be achieved by this embodiment. Lateral coupling can be understood as coupling on the narrow sides or side surfaces of the pane (or protective glass). Particularly preferably, the light-emitting elements of the exposure device are also arranged laterally on the protective glass, so that a coupling prism is not necessary. A protective glass is designed as a plate or pane.

The exposure device can comprise LED strips with integrated diffusers for optimum homogeneous illumination. The diffusers can also be arranged between the LEDs and the protective glass. In an advantageous development, the diffusers are not part of the LED strips, but are arranged between the LED strips and the protective glass (in particular at least one side surface of the protective glass), for example inserted or directly connected, for example adhesively bonded, to the protective glass. The diffuser can be designed as a diffuser pane in which the light beams are diffusely scattered. The exposure device can be part of an optical inspection system and have reflective surfaces, for example metallic surfaces (e.g. convex lenses), in order to achieve homogeneous illumination of the protective glass and a beam path which is as parallel as possible.

The diffusers can preferably be designed differently. Preferred diffusers consist of a transparent or semitransparent material which is capable of scattering the light, such that it not only emerges directly from the LED, but is distributed over a larger area. Different types of diffusers are suitable for the advantageous exposure of the protective glass. One type is a plastic diffuser which can be either opaque or translucent. Opaque diffusers prevent the light from emerging directly from the LED and scatter it uniformly over the surface of the diffuser. Translucent diffusers allow a certain passage of light, but also scatter it in order to achieve uniform distribution. A further advantageous type of diffusers which can be used in LED strips are strips of silicone. Silicone diffusers are flexible and can be applied to the LED strips. They scatter the light and prevent glare effects. The proposed diffusers can also have different surface structures in order to further optimise the scattered light. Diffusers can have a smooth surface, while in an advantageous development, diffusers with a microstructured surface which scatters the light more uniformly are used. Uniform illumination without shadow formation and with uniformly intense luminosity is achieved.

The LEDs can be preselected such that the emission wavelength of some or particularly preferably all LEDs of the exposure device (for exposing the object plane) is in the range of 520-522 nm, with a preferred maximum half-width of 32 nm (or +/−16 nm). Alternatively or additionally, LEDs with white light can also be provided particularly advantageously. In an advantageous development, only LEDs with white light are provided. In a particularly advantageous development, the LEDs are ultraviolet LEDs, UV LEDs, which are combined with a plurality of different phosphors in red, green and blue in order to achieve particularly accurate color reproduction. Additionally or alternatively, red, green, blue light-emitting diodes, so-called RGB LEDs and/or particularly preferably RGBW LEDs can also be used. Alternatively or additionally, colored LEDs can be provided such that the resulting light for exposing the object plane is green.

RGBW LEDs enable the color change by having four different color channels: red (R), green (G), blue (B) and white (W). In contrast to conventional RGB LEDs which have only three color channels, RGBW LEDs add an additional white channel in order to enable a greater color diversity and better white representation.

The color change in RGBW LEDs is preferably effected by controlling the intensity of the individual color channels. By adapting the brightness and mixing of the color channels, different color tones can be generated. For example, a yellow tone can be generated by mixing red and green, while the combination of blue and red leads to magenta.

The control of the color change in RGBW LEDs can be effected via different methods. A preferred method consists in regulating the brightness of each individual channel by pulse width modulation (PWM). In this case, the LED is switched on and off at high speed, wherein the ratio of on and off time results in the desired color. By rapidly switching the channels back and forth, flowing color transitions can be generated.

Furthermore, RGBW LEDs can preferably also be controlled via digital control systems such as DMX or other protocols. In this case, digital commands for changing the colors and effects are sent to the LEDs, which enables precise and versatile control. Uniform illumination without shadow formation and with uniformly intense luminosity is achieved.

Overall, RGBW LEDs enable an extended color palette and more precise color mixing on account of the additional white channel, which leads to a wider palette of illumination possibilities. Uniform illumination without shadow formation and with uniformly intense luminosity is achieved.

Particularly preferably, the LEDs are preselected such that the spectral range of the LEDs is in the range of ±10 nm around 525 nm. Excellent detection of contamination and damage states of the protective glass was achieved by this specific range. In particular even in a case in which manual detection is carried out by means of visual checking, the contamination and damage states can be detected very well. Uniform illumination without shadow formation and with uniformly intense luminosity is achieved.

Preferably, a fluctuation in the color temperature of the LEDs can be selected such that they do not exceed a value of +/−2% by a predetermined value.

Particularly preferably, the LEDs with (or without) lens part are designed such that the emission angle of the individual LEDs is in the range of 120° to 180°. Advantageously, the emission angle of the LED strips of the exposure device is substantially 120° or 180°.

In a development, the same number of LEDs is arranged on each side surface of the protective glass for homogeneous exposure of the object plane. Alternatively, on account of a mismatch between LED minimum strip length and circumference of the protective glass, at least one edge can be provided with fewer LEDs, for example.

In an advantageous development, the lens body of the LED is a Fresnel lens for emitting light beams with a parallel beam path. The light beams emitted by the LEDs in the lens body are refracted when emerging at the surfaces of the Fresnel lens, such that the beam path of the light beams (in the protective glass) extends in parallel.

The parallelism of the beam path of the light beams emitted by an LED can be further improved by the LED having a cross section which increases in the emission direction.

Preferably, the manufacturing system comprises a camera sensor for detecting the object plane, wherein the camera sensor is designed such that it has the highest quantum efficiency in the range of the wavelength of 520 nm and the LEDs of the exposure device are configured to emit light with a wavelength of 520 nm.

Particularly preferably, the maximum of the quantum efficiency of the camera sensor corresponds to the emission wavelength of the LEDs, wherein this is preferably at 520 nm. Uniform illumination without shadow formation and with uniformly intense luminosity is achieved.

Advantageously, a bandpass filter can be attached in front of the camera lens, which bandpass filter is adapted to the emission wavelength of the LEDs in order to filter external light sources, The exposure device can comprise LEDs arranged uniformly on a printed circuit board with an arrangement density of at least 512 LEDs per 1 m, at a power consumption of substantially 11.7 W/m. Particularly preferably, the distance between two adjacent LEDs is only up to 20 mm. Uniform illumination without shadow formation and with uniformly intense luminosity is achieved.

Advantageously, the LEDs are selected such that a fluctuation in the light intensity of the LEDs does not exceed a value of +/−15%, preferably a value of +/−10%, by a predetermined value. Particularly advantageously, the illumination can be operated with a constant voltage of 24 V. Uniform illumination without shadow formation and with uniformly intense luminosity is achieved particularly energy-efficiently.

In order to further improve the uniform illumination with uniformly intense luminosity, the LEDs can be preselected such that the predetermined value of the luminous flux of the LEDs is substantially in the range of 1200 to 1400 Im/m and particularly preferably at 1380.6 lm/m. Uniform illumination without shadow formation and with uniformly intense luminosity is achieved.

Particularly advantageously, the LEDs can be formed as chip-on-board LEDs (COB LEDs) without lens part. Uniform illumination without shadow formation and with uniformly intense luminosity can thereby be achieved.

A method for determining a state, in particular a soiling and/or damage state, of a protective glass of a manufacturing system based on optical interactions can comprise at least one of the steps: exposing the object plane by the exposure device; detecting light intensity values of the object plane of the protective glass by a camera sensor and analysing the detected light intensity values for identifying damage and/or contamination, and/or visually checking the protective glass by a system operator, with the exposure device activated for detecting damage and/or contamination of the protective glass. Uniform illumination without shadow formation and with uniformly intense luminosity is thus achieved.

In a development, the method comprises the step of detecting an object plane associated with the protective glass of the manufacturing system by the camera sensor with simultaneous exposure of the object plane by the exposure device.

The object plane to be detected can be divided into a plurality of evaluation regions and the individual evaluation regions can be evaluated independently for determining the degree of damage or contamination of the protective glass.

The embodiments mentioned thus make it possible to provide an improved manufacturing system. In particular since the brightness sensitivity of the human eye is highest for green light during day and night, impurities and defects can be perceived in a significantly more sensitive manner during automatic cleaning and in particular also during manual cleaning during process preparation. In addition, different cameras with CMOS chips can be adapted such that the peaks in quantum efficiency (the probability with which a pixel converts an incident photon into a charge) are matched to the exposure device. As a result, a camera-based monitoring solution can provide image recordings with higher sensitivity to protective glass contaminants and defects.

The use of an optimised exposure device is thus proposed, which comprises light chains which are coupled laterally into the protective glass. The radiation coupled into the protective glass is reflected by respectively present contaminants. As a result, these are perceived as lighter regions. Radiation in the green wavelength range (in particular 450 to 550 nm) is advantageously used for the light. The proposed solution can thus be used in principle independently of the shape of the protective glass.

The analysis device or device according to the present invention can in this case preferably comprise at least one optical sensor device for detecting an object plane associated with the protective glass or the protective glasses of the manufacturing system, i.e. lying directly on the protective glass, and an exposure device for exposing the object plane (detected by the sensor device in the preferred case), which are preferably configured to reveal existing protective glass states for the above-mentioned optical sensor device on the basis of the exposure device, specifically by exposure of structures occurring on a protective glass, such as contamination, damage or aging structures (e.g. contaminations: process by-products such as soot particles, melts, but also residues of improper cleaning such as streaks, fibers and/or (dust) particles; damage: scratches, flaking, burns or damaged coatings and aging phenomena such as e.g. bleaching within the protective glass), and to locate the mentioned structures accordingly with the aid of the optical sensor device. The present analysis device thus preferably forms an at least two-part device system which is capable with the aid of the first device (the optical sensor device) of directly and spatially resolved identifying abnormal states located on one or more protective glasses, such as for example contamination and damage, whereas the second device (the exposure device) ensures that the above-mentioned structures are made visible in a manner designed for the optical sensor device as precisely and uniformly as possible. Consequently, it is possible with the present invention to provide an analysis device which can determine the state of one or more protective glasses not by given optical (and thus influenceable) secondary effects, but in particular by the direct identification of individual bodies and/or defects to be found on the protective glass, as a result of which a much more precise and error-prone detection mechanism is implemented.

Possible alternative embodiments of the present invention can additionally also include in particular continuing simplifications of the above-mentioned analysis device. Thus, for example, it can equally be possible that, in addition to or instead of the above-described exposure device, an external exposure source, for example a construction space light integrated within the corresponding manufacturing system, can also be used in order to uncover any anomalies of the mentioned protective glass, as a result of which in particular an even more compact analysis device, which is thus easier to integrate into a manufacturing system, can be provided. Accordingly, in a further, particularly preferred exemplary embodiment, the analysis device can for example also be designed at least in such a way that it comprises only the above-mentioned sensor device, but not the exposure device, and can analyze the state of the protective glass to be assessed, e.g. on account of the externally or otherwise generated exposure, solely by this sensor device.

In this case, the optical sensor device itself can preferably comprise at least one optical sensor, such as for example a photodiode, a CCD sensor, a CMOS sensor, or a sensor system connected to an optical sensor, which sensor system can be coupled to correspondingly controllable optics, such as for example focusing or scattering lenses, mirrors or optical filters, in order to detect the above-mentioned object plane belonging to the protective glass/protective glasses, and is thus capable, depending on the optical properties of the above-mentioned elements, of focusing on at least one arbitrary, three-dimensional point within the given system to be measured. Accordingly, in a preferred case, the detection of the above-described object plane can also be understood at least as signal detection, in which a signal emanating from the focusing plane of the optical sensor device can be guided to the respective sensor (image plane) and can thus be identified and evaluated in further process steps. Particularly preferably, the maximum of the quantum efficiency of the optical sensor device corresponds to the emission wavelength of the LEDs of the exposure device, wherein this is preferably substantially in the wavelength range of 450 to 550 nm and particularly preferably at 520 nm.

In a further embodiment, the spectral range of the LEDs is in the range of ±10 nm around 525 nm. Preferably, a fluctuation in the color temperature of the LEDs cannot exceed a value of +/−2% by a predetermined value.

Based on these properties, the optical sensor device can accordingly be configured in particular to generate an at least one-dimensional image of the respectively detected object plane from the above-mentioned signals. In a particularly preferred case, the optical sensor of the optical sensor device can in this case also be configured in particular as an imaging sensor, for example by implementing a sensor based on a single or a plurality of pixels and/or a coupled, scannable lens system, such that each point of the object plane detected by the optical sensor device can be identified as an element of a spatially resolved, at least one-dimensional, but in particularly preferred cases above all two-dimensional image. It is subsequently possible with the aid of the optical sensor device, depending on the selected orientation of the implemented optics, to focus a preferably arbitrary plane (object plane) connected to one or more protective glasses and reproduce it in a spatially resolved manner as one or two-dimensional, signal-dependent image.

In order to ensure as accurate an identification as possible of existing structures to be found on the protective glasses, such as the above-mentioned contamination, damage and/or aging structures, the above-mentioned object plane of the sensor device can moreover preferably be positioned in parallel and at the level of the contaminated optics surface (in particular a protective glass outer surface which faces the process region) for accurate assessment of the state of a protective glass, as a result of which a maximum image sharpness with regard to the particle identification can be implemented. Alternatively, however, it can likewise also be possible to define a plurality of object planes lying, for example, at different heights or in different cross-sectional axes of the protective glass, which can be approached by preferably automatic actuation of the optical elements situated in the sensor device, preferably one after the other, and can thus be used for generating further measurement data.

Accordingly, for example, in addition to the above-mentioned two-dimensional images of the contamination, damage and/or aging structures situated on a protective glass, a three-dimensional representation, based on a plurality of image planes, of the elements lying in the detected object planes can also preferably be generated, which enables additional information, such as shape or height of the structures accumulating on a protective glass. Likewise, the optical sensor device can preferably also be configured in particular to allow a maximum resolution within the individual images generated by the sensor device to detect only individual, local areas within a specific plane, as a result of which, for example in sensor devices based on pixel sensors, the pixel-to-image rate can be increased as desired. For this purpose, the sensor device can moreover preferably also be equipped with further image-improving mechanisms, such as an autofocus, dichroic filters or filters defined at specific wavelengths or image processing processes based on software, which preferably automatically adjust the sharpness and the information content of the recorded images both during and after the recording process and thus enable optimum detection of the contamination state.

The signal to be detected by the optical sensor device can in this case, as already mentioned above, preferably be generated by exposure of at least the object plane to be detected by the exposure device or else an external exposure source equally implemented in the analysis device. In a particularly preferred embodiment, the exposure device can for this purpose transmit mono-or multichromatic light at a predefined angle of incidence onto a protective glass to be analyzed or the object plane associated with the protective glass, wherein a signal field dependent on the last-mentioned structures can be generated by the interaction of the light irradiated by the exposure device with the contamination, damage and/or aging structures adhering to the protective glass.

Thus, in a first preferred exemplary embodiment, the exposure device can furthermore preferably be arranged in particular as an incident light source oriented with respect to the previously described sensor device. Accordingly, the exposure device in this case is configured to generate the light generated for illuminating at least one protective glass from the side of the protective glass facing the optical sensor device and to let it impinge on the protective glass, such that, in the case of a completely clean or fault-free surface of the protective glass, the exposure proceeding from the exposure device can pass completely, i.e. substantially without a reflection, through the protective glass and thus cannot impinge on the optical sensor device. Accordingly, on the basis of this construction, for example the scattered light generated by the respective contamination, damage and/or aging structures can be used as sensor signal of this exemplary embodiment in order to identify the structures, and thus the contamination or damage or aging state of the protective glass, efficiently and localized, since any light emanating from the exposure device (naturally) can be effectively kept away from the optical sensor device. Consequently, the detection process of the analysis device in this embodiment of the exposure device provides for generating an illumination by the exposure device of the object plane to be detected by the optical sensor device or of the at least one protective glass belonging to the object plane which is initially as homogeneous as possible and for detecting the scattering patterns thus generated at the contamination, damage and/or aging structures of the protective glass for localizing the individual structures at the sensor device.

In order to improve the process mentioned, the exposure device in this case can also comprise, in addition to an exposure light source required for the exposure, such as for example an LED, a light diode system or a laser, further elements, such as for example additional polarization, intensity or color filters, focusing and scattering lenses or condensers suitable for example for beam homogenization (e.g. honeycomb condensers), which condensers can preferably be coupled to the exposure light source and can be present in a manner controllable both manually and in an automated manner. Accordingly, in a preferred case, the optical elements of the optical sensor device and of the exposure device of the present invention can also act matched to one another and, depending on selected settings within the one device, bring about an automatic adaptation of the elements of the other device. By way of example, the exposure device can be configured to change the light intensity generated by the exposure light source, for example depending on external parameters, or to adapt the spectral bandwidth thereof by introducing further filters, as a result of which filter or optical elements equally located in the optical sensor device are automatically added or removed for improved analysis.

In order to further improve the exposure quality, the exposure device can additionally be configured to carry out the illumination of the object plane detected by the optical sensor device also continuously or also in a pulsed manner or to efficiently adapt the angle of incidence of the light used for the illumination at least by mechanical reorientation of the exposure device. Equally, a plurality of exposure light sources or optical elements coupled thereto can also be provided or, equivalently to the optical sensor device, only predefined partial areas of the detected object plane can be illuminated by the exposure device, as a result of which in particular high exposure intensities are made possible.

Further embodiments of the exposure device can additionally preferably also comprise the use of other types of exposure. By way of example, in a second preferred embodiment, the exposure device can also be configured to implement transmitted light illumination to be used for detecting the contamination, damage and/or aging structures, counter to the incident light process of the abovementioned first embodiment. For this purpose, the exposure device can be fitted, for example, in a particularly preferred case, at least on that side of the at least one protective glass to be detected which faces away from the optical sensor device (and spaced apart from the protective glass), such that the protective glass illumination generated by the exposure device reaches the protective glass in the defect-free or contamination-free state of the protective glass and illuminates the latter in a reflection-free manner and also impinges on the individual pixels of the sensor device located behind the protective glass.

Accordingly, it is equally possible in this embodiment to detect individual contamination, damage and/or aging structures on one or more protective glasses by virtue of the fact that, in this case, it is not the scattered light emanating from the structures but, vice versa, the intensity loss of the light arriving at the sensor device caused by the scattering of the transmitted light at the structures that can be localized. Consequently, the above-described embodiments of the exposure device can differ per se, in addition to the positioning of the exposure device, in particular by virtue of the fact that the contamination, damage and/or aging structures to be detected in the first embodiment are manifested in the image generated by the optical sensor device as geometries with much higher intensity in comparison with the detected background radiation, whereas the detected image background of the second embodiment generally has strong signals on account of the additionally detected transmitted light illumination, but exhibits a substantial signal impairment at supposed structure locations. Consequently, both of the abovementioned embodiments can implement an efficient and simultaneously precise methodology for the spatially resolved identification of any protective glass states, which can subsequently take into account both preferred device positions and exposure types to be used.

Further embodiments of the above-mentioned exposure device can additionally preferably also have a combination of the abovementioned types of exposure, for instance by introduction of light sources into a space situated in front of and behind the protective glass with respect to the position of the optical sensor device, the attachment of the exposure device directly to the optical sensor device or else even the omission of the exposure device and the exposure of the protective glass solely by external exposure sources, such as for instance tree-room light present within the associated manufacturing system, as a result of which in particular an extremely compact shape of the analysis device can be generated. In a further embodiment to be identified as the third, the exposure device can additionally preferably also be attached laterally to a protective glass surface to be detected (in particular laterally as LEDs arranged on the narrow side of the respective protective glass or LEDs arranged in a ring shape), so that, in comparison with the above-mentioned cases, radial exposure, that is to say exposure from the outside of a protective glass to the center thereof, can be implemented. The latter makes it possible in this case to generate in particular lateral irradiation of the protective glass structures to be analyzed, as a result of which further advantageous effects arise for the detection processes to be carried out by the optical sensor device.

Accordingly, it is apparent that an effective and simultaneously more precise analysis of the states existing on at least one protective glass can be implemented by the detection mechanism to be generated with the aid of the present analysis device. Furthermore, it should be noted that the above-mentioned simple design form of the present analysis device, consisting only of one or two device elements (the optical sensor device and (optionally) the exposure device), allows far more flexible adaptation to the respective conditions occurring within different manufacturing systems.

Thus, for example, on account of the direct analysis (and thus independent of any elements introduced into the manufacturing systems) of the at least one protective glass by the sensor device, the analysis device of the present invention can in a preferred case also be designed as an analysis unit which can be integrated into already existing manufacturing systems, as a result of which in particular the technical added value of the present invention is increased once again.

Consequently, it can also preferably be possible in the present invention to introduce the previously described device elements of the analysis device in particular without interference into the construction of a respective manufacturing system based on optical interactions.

For this purpose, the analysis device can preferably be configured to be integrated or positioned at least along the light path of the manufacturing system arising through the manufacturing light source, such that not only as short as possible a detection distance can be constructed between the above-mentioned optical sensor device and the at least one protective glass to be analyzed, but equally also corresponding free spaces existing in the manufacturing system can be made usable for the integration of the respective device elements. Thus, for example, due to the optical properties and the thus arising working distances of the optical manufacturing elements defining the light path, recesses exist in manufacturing systems based on optical interactions, which are used only for beam manipulation (focusing, scattering, widening, etc.) of the light beam used for the manufacturing and can thus potentially be used for the integration of further devices. Accordingly, in a particularly preferred case, the analysis device of the present invention can in particular be set up to use just such free spaces within a manufacturing system and to introduce its existing device elements, but at least the optical sensor device, into these free spaces for efficient integration which is harmless to the manufacturing process. Consequently, the above-mentioned positioning results in the advantages that the optical sensor device can not only be arranged particularly space-saving, but equally also in particular independently of the usual manufacturing processes, as a result of which the former, at least additionally, can be effectively protected against possible contamination and/or damage. Consequently, in a particularly preferred exemplary embodiment, the optical sensor device of the present analysis device can be configured to be arranged at least between the light source and the protective glass of the manufacturing system for efficient integration of the analysis device into the manufacturing system, such that the free spaces existing along the light path of the manufacturing system can be effectively used.

In a preferred exemplary embodiment, the optical sensor device can preferably be configured for this purpose to be integrated at least between the light source and the optical manufacturing elements of the manufacturing system set up for modifying the manufacturing light beam, as a result of which in particular the free spaces existing between the optical manufacturing elements can be effectively used. Equally, in this case, it can also preferably be possible for the optical sensor device to be integrated into the light path of the optical manufacturing elements, for example by the implementation of additional mirror axes, such that likewise already existing portions of the manufacturing system can be effectively used for the detection of the protective glass or the object plane associated with the protective glass which is made possible by the sensor device.

In a further preferred exemplary embodiment, the optical sensor device can additionally also be configured to be arranged in particular between the above-mentioned optical manufacturing elements and the at least one protective glass of the manufacturing system. Correspondingly, the optical sensor device can in this case preferably be set up to be positioned in the free space of the manufacturing system used for ultimately focusing the manufacturing light beam onto the material to be manufactured, which preferably enables the sensor device to detect the protective glass to be analyzed directly, i.e. without the aid of further optics existing within the manufacturing system. In this respect, the sensor device in this exemplary embodiment has in particular the advantage of implementing an equally precise and also independent detection of potential protective glass states by direct measurement of the one or more protective glasses.

The exposure device of the present analysis device can furthermore, as already mentioned above, likewise be configured to be arranged in one of the previously described positions or free spaces of the manufacturing system. It can preferably be provided in this case to position the exposure device in particular in a free space to be occupied jointly with the sensor device, such that the analysis device can be integrated into the manufacturing system as a whole, i.e. as an object to be physically identified.

The precise positioning of the corresponding device elements of the present analysis device can, however, in order to ensure the functionality in different manufacturing systems, be adapted depending on the construction of the manufacturing system to be equipped, and can be implemented for this purpose by further, preferably mechanical, structures attached to the device elements, such as adjustable springs, rails or angle mechanisms, by displacement and reorientation of the device elements. In order to likewise ensure the highest possible security and detection quality, the previously described device elements can moreover preferably additionally also be attached to a fixedly installed and preferably displacement-free construction, such as a framework structure, for example, such that any influences acting on the analysis device and reducing the process quality thereof can be reduced to a minimum.

In a particularly preferred exemplary embodiment, the analysis device can furthermore also comprise for this purpose at least one independent protective housing, in which the optical sensor device and/or the exposure device can be introduced and protects the latter equally against any process emissions occurring in the manufacturing system, such as dust, smoke or material residues. Accordingly, the above-mentioned protective housing can preferably be configured to enclose the previously described device elements at least laterally, but in particularly preferred embodiments also completely, i.e. from all sides, such that a preferably inert space can be created by the protective housing.

The determination of the respective state of the protective glass or the protective glasses to be examined by the analysis device can, however, preferably be made possible by evaluating the information generated by the optical sensor device, such as the signal values or the intensity values of the already above-mentioned image of the respectively detected object plane associated with the protective glass.

In this respect, the analysis device can preferably be configured to first transfer the previously described information at least as digital information files to a provided memory device connected to the sensor device, in which said information files can be stored permanently or for a predefined period of time and can thus be provided for further evaluation processes. The connection between the sensor device and the memory device can in this case be effected via a physical connection, such as a cable or a direct integration of the memory device, for example as an integrated memory chip or hard disk, or else also by wireless communication, such as Bluetooth, W-LAN or infrared signals, such that, depending on the selected embodiment, an extremely efficient data transfer can be made possible at any time.

For further evaluation of the information files stored in this way, the analysis device can then, in a first embodiment, be configured to transmit predefined components of current information or information detected or processed in the past to a preferably optical output unit, such as a screen existing on the manufacturing system, and thus to allow at least a manual estimation of the current protective glass state by available specialist personnel. Accordingly, it can be possible for example that, in the case of an imaging sensor device, the image of the detected object plane generated by the optical sensor device (and consequently the (soiling, damage and/or aging) states to be seen thereon) can be generated as a visual, at least two-dimensional image on the output unit, which image can subsequently be used, by the evaluation of a specialist personnel or in an automated manner by a corresponding computer program, to estimate the current protective glass state. Likewise, the output unit can also preferably be configured to obtain information data from different recording steps and/or recording times and to present corresponding time profiles or changes in recorded, selected signals to the specialist personnel.

In a further embodiment, the present analysis device can additionally preferably also comprise, in addition to or instead of the output of detected information for manual analysis of existing protective glass states, at least one evaluation unit for automated evaluation of the above-mentioned information. The evaluation unit itself can in this case preferably be arranged as an independent computing unit, for example as a processor connected to the further device elements of the analysis device, and can in particular be configured to use the information generated by the sensor device for evaluating the protective glass state by means of computing rules implemented or programmed in the evaluation unit.

For this purpose, the evaluation unit can in a preferred case likewise be connected at least to the above-mentioned memory device of the analysis device, as a result of which the latter is made possible to access the information data stored within the memory device and potentially to include both currently new information and information generated by previous analysis processes in the evaluation process. In a particularly preferred case, the evaluation unit can additionally also be configured to insert further parameters, such as predefined limit values, physical constants or information produced by the generation of the information files, such as metadata, into the process, as a result of which in particular complex evaluation mechanisms based on a plurality of conditions are made possible.

The evaluation process itself carried out by the evaluation unit can in this case initially preferably comprise at least the determination and output of a degree of state defining the state, in particular the contamination, damage and/or ageing state, of the at least one protective glass, also referred to below as the degree of damage, contamination or ageing, which degree of state is in particular configured to represent the current state of one or more protective glasses and the associated measures in a simple manner. Accordingly, the degree of state can be represented in a preferred form, for example, as a simple number, for example in a scale format from 1 to 100, in which a low (degree of state) number can express a inferior state and a high can express a good, i.e. preferred, error-free and/or high-quality state of a current protective glass, as a result of which in particular a given specialist can be effectively guided both in the evaluation of the current protective glass state and in the measures to be carried out thereupon, such as the cleaning or the replacement of the at least one protective glass, when identifying the output, current degree of state of the respective protective glass. In addition to or instead of the above-mentioned scale format, the degree of state calculated by the evaluation unit can additionally also contain more discrete information, such as the type of protective glass state (e.g. physical damage to the protective glass, identified impurity layers, streaks, etc.) or an estimate given by the analysis device for the further course of the process (e.g. “continuation of the process”, “required cleaning” or “required replacement of the protective glass”), such that even unskilled specialist can identify existing sources of problems and can efficiently initiate further maintenance processes.

Accordingly, the calculation and output of the above-mentioned degree of state by the analysis device can be used in particular to generate an automated and at the same time easily comprehensible estimate with regard to the current state of at least one protective glass detected by the optical sensor device, such that, on the one hand, a point in time required for the restoration/cleaning of the protective glass can be estimated as accurately as possible, but, on the other hand, the quality of the latter restoration processes can also be efficiently checked, specifically for the subsequent problem-free recommissioning of the corresponding manufacturing system. Thus, for example, it can likewise be possible for the analysis device to be configured, in particular after a corresponding cleaning and/or replacement process of a protective glass, to check the degree of state of the processed protective glass again and thus to indicate to the current operator of the manufacturing system, by outputting a discrete statement based on this check (e.g. a message such as “cleaning successful/completed”, “protective glass still defective”, “streaks/damage detected”), possible inefficient cleaning steps or an error effected during the new protective glass integration, as a result of which any process sequences carried out within the manufacturing system can be improved even further.

In order to determine the previously described current protective glass state or the degree of state to be used for this purpose, the evaluation unit can, however, preferably be configured both to extract predefined information from the signal values generated by the optical sensor device and to evaluate said information and also to compare said information with a plurality of reference information stored in the memory device, such as signal values from previous analysis processes or the already above-mentioned additional parameters, such that the degree of state to be calculated can preferably be identified at least as a comparison value between the currently detected state of at least one protective glass and a previous point in time, for example a point in time at which the protective glass was present in a state-free, i.e. for example damage-free and/or contamination-free, state. In a particularly preferred exemplary embodiment, for this purpose, for example, an already predefined information file can be stored in the memory device which indicates the protective glass state specifically directly after installation into the manufacturing machine or a cleaning process, and thus allows the evaluation unit, by adding this information, to calculate the degree of state in particular as a comparison between the current state and an optimum state.

As information to be used preferably for determining the degree of state and obtained from the optical sensor device, the evaluation unit can additionally be configured to calculate said degree of state at least on the basis of the intensity values present in the images of the sensor device.

Thus, the evaluation unit can be configured, for example, in a first exemplary embodiment, to analyze at least the intensity values within the given image of the sensor device and subsequently to calculate the desired degree of state at least by forming a relative difference value between the above-mentioned intensity value of the current image (for example by calculating image-related mean values) and that of an earlier protective glass state, for example the previously described optimum state. This has in particular the advantage that a simple and also efficient measure of the damage or contamination or aging of the given protective glass can be generated by the given correlation between the light intensity recorded by the sensor device and the strength of contaminants or damage or aging phenomena on the detected at least one protective glass (the greater the contaminant/damage/aging bleaching, the greater the intensity differences generated by the scattering effects) and can thus be made usable as a basis for the degree of state to be calculated. Accordingly, the determination of the degree of state in this first exemplary embodiment can at least provide for calculating the above-mentioned difference intensity value and subsequently converting it into the desired degree of state with the aid of further process steps, such as the comparison with predefined limit values or the implementation of further parameters.

In a particularly preferred exemplary embodiment, the evaluation unit can additionally likewise be configured to include in particular also any two-dimensional information made possible by the imaging sensor device within the generated images in the calculation. Thus, the evaluation unit can be capable, for example, of also using, in addition to or instead of the above-mentioned intensity values, the number and/or the size of the soiling, damage and/or aging structures represented in the images for determining the degree of state, as a result of which in particular an analysis process can be generated which is independent of any optical values and thus more precise in comparison with the state of the art.

For this purpose, the calculation of the degree of state on the basis of this second exemplary embodiment can accordingly firstly comprise at least the detection of any structure contours or geometries to be found in the respective image, which detection can, preferably, likewise be effected as a function of intensity values to be found in the image. By way of example, the detection process can comprise a segmentation step for this purpose, in which the evaluation unit takes the intensity values of individual pixels of the image to be analyzed and identifies contiguous bodies, such as pixel groups lying next to one another, which have for example a predefined intensity value or exceed a specific limit value, as one of the above-mentioned structure geometries. Accordingly, precise indications about the size, geometry or any agglomeration areas of the soiling, damage and/or aging structures detected on the image can be generated by the additional information thus obtained, such as the pixel positions of the pixels belonging to a specific pixel group/structure or a specific intensity value, which additional information can likewise be included in the calculation of the degree of state and can subsequently make possible an extremely exact state evaluation based on direct, i.e. actually existing properties of the protective glass.

Based on these circumstances, the evaluation unit can consequently preferably be configured to integrate at least one of the above-mentioned properties of the detected damage, soiling and/or aging structures into the subsequent determination of the degree of state in addition to or instead of the previously mentioned intensity values of the image. By way of example, the degree of state can be defined, at least partially, as a function of the area claimed by the detected structures (preferably relative to the total area of the generated image), such that the degree of state becomes qualitatively lower with increasing wetting of the at least one protective glass. Alternatively, for this purpose, the number of detected structures, the size, shape thereof or else also the structure density or the position of the individual structures identified within the image can also be included in the calculation and combined with one another via different calculation methods, such as predefined weightings, such that the ultimate degree of state can also be understood as an evaluation of different circumstances occurring on the at least one protective glass.

In this respect, the above-mentioned two-dimensional identification process and the calculation of the degree of state based thereon thus results in particular in the advantage that an automatable evaluation of the protective glass state can be produced which can use not only any effects generated by the soiling, damage and/or aging of a protective glass, but can also include in particular explicit properties of the structures situated on one or more protective glasses (process emissions, damage sites, local bleaching, etc.).

Further potential advantages can additionally also result from additional process and/or analysis steps. Thus, by way of example, it can preferably be possible for the evaluation device, after the localization of any structures situated on a protective glass, to likewise identify the latter with a predefined structure type (e.g. “dust residue”, “smudge deposit”, “scratches”, “cracks”, “bleaching” etc.) (for example by comparing the previously mentioned structure geometries) and to adapt the degree of protection in accordance with the respectively analyzed structure types. By way of example, in the case of structures identified mainly as dust, the evaluation device can generate an output for cleaning the protective glass, whereas, in the case of the identification of a majority of cracks, the replacement of a respective protective glass can be proposed. Accordingly, it is apparent that far more specific state analyses (and corresponding treatment steps) can also be implemented by the two-dimensional information of at least one protective glass additionally obtained with the aid of the imaging sensor device.

In a particularly preferred exemplary embodiment, the evaluation device can additionally also be configured to divide the image of the detected object plane generated by the optical sensor device into a plurality of different evaluation regions, as a result of which it is made possible in particular to consider any local influences acting on a protective glass separately and to include them for more precise evaluation of the degree of state or of the general manufacturing process. Thus, by way of example, it can be possible that, in particular in heatable manufacturing systems, any structure agglomerations generated by temporary temperature differences can form on a protective glass, which leads to a local increase in the structure density within the generated image, but can have only little influence on the general manufacturing quality of the manufacturing installation on account of the merely spatially restricted structure distribution. In this sense, a further process step of the evaluation unit can preferably at least comprise identifying the above-mentioned local differences in the structure distribution by dividing the image to be analyzed into a plurality of evaluation regions and, for including the previously described circumstances in the determination of the degree of state, evaluating the individual evaluation regions at least independently of one another.

In a further preferred exemplary embodiment, the evaluation unit can additionally also be configured to compare the images to be analyzed, similarly to the intensity value analysis already mentioned above, before the localization of the individual protective glass structures initially likewise with preceding protective glass states. Preferably, for this purpose, the last-mentioned image can initially be compared by way of example with a predefined image which, under the same optical conditions, can indicate an optimum protective glass state, such that possible signal values not associated with the structures to be identified, such as for instance intensity gradients or background signals generated by the setting of the analysis device, can be effectively excluded from the further analysis steps. Correspondingly, it can preferably be possible that the evaluation unit, before a respective structure localization step, converts the image to be analyzed initially for example into a difference image, based on the subtraction of the pixel intensity values of the optimum image from the image to be analyzed, and can thus further increase the evaluation precision of the previously described degree of state calculation.

The degree of state calculation itself can furthermore, as already previously described, preferably be effected in each case after the measurement of the respective object plane by the optical sensor device, and the information thus obtained, whether it is the calculated degree of state or any protective glass properties to be extracted from the images, can be stored in the memory device after the analysis by the evaluation unit. Subsequently, it can equally be possible to create, with the aid of the process sequence mentioned above, a state history of one or more present protective glasses present in the memory device, which state history, in addition to the advantage of the renewed addition of any data, for instance for the above-mentioned difference image calculation, can equally be used for predicting future protective glass properties.

Thus, in a further preferred exemplary embodiment, the analysis device can be configured to determine the contamination, damage and/or ageing state of at least one protective glass, in particular also continuously or at predefined time intervals, as a result of which a precisely defined measurement series of determined data with respect to the contamination, damage and/or ageing state can be generated and stored in the memory device for the analysis of further protective glass parameters. In this case, the measurement series can preferably comprise time profiles, such as for instance the changes in the protective glass state or the degree of state detected per unit of time, and any properties of the system present around the protective glass, e.g. production steps carried out over time, detected temperatures or mechanical/optical effects on the protective glass, such that, depending on the conditions present within the respective production plant, a specific data library tailored to the production plant can be implemented.

In this respect, the analysis device can preferably be configured to use in particular the above-mentioned measurement series of past analysis processes within this data library in order to generate estimates with respect to preferred procedures with regard to the current protective glass state. By way of example, in a preferred case, the analysis device can be configured to compare already existing measurement series, in particular measurement series which were recorded within identical or similar production conditions, with the currently calculated protective glass states or degrees of state and, for example by extrapolation of the degrees of state profiles to be detected in the measurement series, to calculate a remaining service life of at least one protective glass to be obtained on the basis of these past measurement series. Alternatively, preferably in addition to the service life, further parameters, such as for instance a preferred time period up to a required cleaning, repair or replacement of a protective glass, can also be determined.

It can be seen below that, with the aid of the above-mentioned and claimed analysis device, a wide range of preferred advantages can be generated in comparison with conventional protective glass analysis devices of the state of the art, which, on account of the device elements of the analysis device which are simultaneously simple and efficiently to be integrated into existing production plants, can be introduced extremely effectively into preferably any type of production plant based on optical interactions.

Subsequently, a production system based on exposure of workpiece materials and/or workpiece elements is likewise claimed below, which production system equally has the above-mentioned advantages and can therefore be distinguished from conventional production systems.

In this case, the claimed production system can likewise comprise at least one or a plurality of production plants based on optical interactions, in accordance with the previously described definition, and one or more embodiments of the analysis device already defined above and implemented in the production plant. In this respect, the production plant of the claimed production system can firstly be regarded equally as at least one device which comprises at least one light source for processing the mentioned workpiece materials and/or workpiece elements, one or more light paths generated by the light source and used for exposing the workpiece, and one or more protective glasses arranged for protecting the light source against possible damage and/or contamination and can therefore preferably be identified with any conventional optical production plant.

In a preferred embodiment, however, the corresponding production plant of the production system can also be configured in particular to be configured to be usable at least for additive manufacturing of workpieces, such as for instance with the aid of selective laser melting (SLM).

In particular, the production plant based on optical interactions can for this purpose preferably comprise at least one processing chamber, in which the workpiece materials and/or workpiece elements required for workpiece production can be introduced and processed by exposure with the aid of the light source. In this case, the processing chamber itself can preferably, in particular in order to be able to meet the atmospheric conditions required for the SLM method, be configured to be completely closable and in particular be equipped with a number of chemical and/or mechanical regulation elements, which enables the processing chamber of the production system to dynamically adapt the pressure or the chemical constituents of the atmosphere existing within the processing chamber during possible production processes, as a result of which an extremely stable and error-free production method can be realized. Specifically, the processing chamber can for this purpose for example also comprise various inlet and outlet valves for introducing required process chemicals, such as for instance argon, and can at least be configured to hermetically close off the production space defined within the processing chamber, such that the above-mentioned conditions are met at all times.

The one or the plurality of protective glasses of the production plant can additionally, in a preferred embodiment, equally be a component of the processing chamber. Thus, it can be possible for example for the at least one protective glass to be preferably integrated into the housing of the processing chamber or to be configured to be contacted at least in the latter housing, such that the at least one light source can guide the manufacturing light path or the light paths emanating therefrom through the protective glass and/or the protective glasses into the processing chamber. Accordingly, the construction of the production plant can also be configured at least such that the light source can guide a light beam emanating therefrom directly or via possible preferably actuatable optical elements through the at least one protective glass and thus let it impinge on the workpiece material and/or element to be processed.

In this case, as already mentioned, the at least one light source itself can preferably be configured at least as a radiation source configured for plastic deformation of the workpiece elements, such as for instance a laser, and can preferably be capable of moving and/or focusing the light path generated by the light source preferably in any three-dimensional direction via actuatable optical elements (lenses, filters, mirrors, condensers etc.) integrated or positioned externally in the radiation source. Further alignments of the beam system thus generated can additionally also be implemented in a mechanical manner, for instance by moving one or a plurality of exposure housings containing the optical elements and/or the light source of the production plant, such that focusing of the material can be carried out both on a mechanical and on an optical basis.

The at least one analysis device of the production system can, however, as described, be configured to be integrated into the production plant of the production system, preferably in one of the free spaces existing in the production plant. Thus, the at least one analysis device can preferably be positioned for example in the present production system at least between the light source or the exposure housing enclosing the light source and/or the optical elements of the light source and the above-mentioned processing chamber, such that the analysis device can in particular be configured as a unit to be inserted between these two elements. In a particularly preferred exemplary embodiment, the at least one analysis device can additionally also be positioned between a plurality of light sources or exposure housings and the processing chamber

The various device elements of the one or more analysis devices, but at least the optical sensor device, can furthermore, analogously to the above-described exemplary embodiments, likewise preferably be positioned between the processing chamber and the at least one light source of the production system and for example be enclosed by the protective housing of the analysis device.

The special position of the exposure device of a respective analysis device can additionally preferably vary depending on the preferred type of exposure: Thus, in the case of a preferred incident light exposure, as outlined, the exposure device can preferably be attached along the side of a protective glass to be analyzed facing the optical sensor device, such that it is possible to position both the optical sensor device and the exposure device in a common space, for instance the protective housing of the respective analysis device. In the case of transmitted light illumination, by contrast, the exposure device can preferably be positioned on the other side of the mentioned protective glass or of the introduced protective glasses, for example in a separate space within the processing chamber, as a result of which it is made possible in particular also to directly expose the side of the at least one protective glass to be detected that is affected by any contamination or damage. As a third preferred embodiment, it can additionally also be possible, in particular in order equally to implement as uniform an illumination as possible emanating from the side of a respective protective glass, for the exposure device to be introduced into the structure of the processing chamber, for example into the housing or the outer wall thereof, such that not only an extremely space-saving but equally also stable integration of the exposure device is implemented.

Further advantages of the production system can additionally also result from possible interactions between the production plant and the integrated at least one analysis device. Specifically, the analysis device can be configured, for example, to preferably exchange processing and/or process signals with the production plant based on optical interactions, such that corresponding analysis processes of the one or plurality of analysis devices can be matched efficiently to existing production steps of the production plant. Accordingly, the at least one analysis device can be configured, by way of example, to obtain at least information with respect to existing work processes of the production plant and/or to send it back, such that the determination of the contamination, damage and/or ageing state of the at least one protective glass carried out by the analysis device can be effected after predefined production processes, for instance before the start or after the end of a workpiece production or for instance during predefined waiting times, in particular in an automated manner. Conversely, however, the production plant can also be configured, on the basis of information obtained by the analysis device, to adapt its production process to the embodiments of the analysis device(s), as a result of which an extremely efficient and in particular dynamically acting interaction of a respective analysis device with the existing production sequences of the production plant can be implemented.

Accordingly, it can be possible, by way of example, for the production plant to obtain information with respect to the current state of a protective glass implemented in the production plant regularly, for example at predefined time intervals, by the at least one analysis device and to dynamically align the current and/or a future production process to be carried out according to the above-mentioned information. Thus, the production plant can preferably be configured, for example, after obtaining a negative protective glass assessment (for example after the detection of a local burn-in or a crack), to avoid any light paths potentially interacting with the detected problem (for example by changing the light path geometries used) or to automatically redistribute a current processing process to other light sources or light paths unaffected by the problem described above, such that a permanently constant processing quality can be ensured even during a running production process. Analogously to the above-mentioned or general device elements, individual production steps and/or process parameters, for instance the intensity or the diameter of the light beam to be produced, can additionally preferably also be adapted based on individual information generated by the at least one analysis device, as a result of which a maximum adaptability of the production plant with respect to occurring protective glass states can be achieved.

Further interaction steps between a respective analysis device and the production plant can additionally preferably also be designed such that, in particular, the accuracy and comparability of the information generated by the analysis device can be optimised in the best possible manner, for example in order, in the above-mentioned comparison of images of current protective glass states and those of an optimum protective glass state, to allow an assessment which is as error-free as possible. For this purpose, the production system can correspondingly be configured, in particular, to carry out the analyses carried out by the at least one analysis device at least under constantly identical conditions prevailing in the production system, such as existing background illuminations, workpiece positions or production process times, which reduces any interference signals within the recorded images to a minimum, in particular after generation of the previously described difference images.

In order in this case to bypass, in particular, the background illumination of the protective glass generated by the light source or within the processing chamber of the manufacturing system, the production system can additionally preferably be configured to carry out the detection of the respective protective glass object plane by an optical sensor device only when the light source is switched off or covered. In this respect, a process step of the production system preceding the analysis of the at least one analysis device can comprise at least the switching off and/or covering of the light source or any other light-emitting objects, in order, in particular, to allow constant optical conditions impinging on the optical sensor device.

In a particularly preferred exemplary embodiment, the production system can additionally also comprise, for the above-mentioned purpose, further device elements, such as a flap or sliding element attached in the production plant for shielding one or a plurality of analysis devices, but at least the optical sensor devices thereof, from exposure proceeding from the production plant. Specifically, this flap or sliding element can be configured, for example, as an object which can be moved or pivoted at least in one direction and is as far as possible non-reflecting or strongly absorbing, such as for instance a black-anodized plate or an optical filter element, which can be moved in front of the respective analysis device, the at least one protective glass or the optical device and thus allows, in particular, interfering light paths normally detected by the optical sensor devices to be delimited from the latter. Accordingly, the flap or sliding element can preferably be designed to be movable at least from a first position for shielding said at least one analysis device to a second position for re-exposing said analysis device at least from the sides of the processing chamber and/or the light source and back, as a result of which both the above-mentioned constant condition during the detection by the analysis device and the re-release of any light paths closed by the flap or sliding element can be realized for the general production process. Preferred positions of the flap or sliding element can additionally preferably be selected depending on the respective type of exposure of the exposure device, but comprise at least the positioning of the flap or sliding element in the processing chamber or the analysis device.

The respective process sequences carried out for determining the contamination and/or damage state of the at least one protective glass in the manufacturing plant of the production system can furthermore preferably be the same as those of the already previously described functions of said analysis device. Accordingly, the process steps equally claimed herewith and generated by the at least one analysis device of the present invention can comprise at least one of the following steps:
detecting an object plane of the protective glass of the manufacturing system by an optical sensor device;
exposing the object plane by an exposure device;
evaluating information obtained by the detection of the object plane of the protective glass by an evaluation unit, wherein the evaluation of the information comprises at least the analysis of detected light intensity values;
detecting the state, in particular the contamination, damage and/or ageing state, of the at least one protective glass by the analysis device between predefined production processes of the manufacturing system;
determining a degree of soiling, damage and/or aging of a protective glass by comparing the information obtained by the detection of the object plane by the optical sensor device with predefined reference information, such as limit values;
determining service lives of the at least one used protective glass on the basis of a plurality of information determined by the at least one analysis device with respect to the contamination and/or damage state of the protective glass.

### BRIEF DESCRIPTION OF THE FIGURES

FIG. 1: shows a two-dimensional view of a manufacturing system based on optical interactions, specifically a SLM system;

FIG. 2: shows a two-dimensional view of a manufacturing system of the present invention;

FIG. 3A: shows a detailed view of a first embodiment of the analysis device in a vertical cross section, in which the exposure devices are positioned within the protective housing of the analysis device;

FIG. 3B: shows the embodiment of FIG. 3A as a detailed view in a horizontal cross section;

FIG. 4A: shows a detailed view of a second embodiment of the analysis device in a vertical cross section, in which the exposure devices are positioned in the processing chamber;

FIG. 4B: shows the embodiment of FIG. 4A as a detailed view in a horizontal cross section;

FIG. 5A: shows a detailed view of a third embodiment of the analysis device in a vertical cross section, in which the exposure devices are integrated into the structure of the processing chamber;

FIG. 5B: shows the embodiment of FIG. 5A as a detailed view in a horizontal cross section;

FIG. 5C shows an advantageous arrangement of the exposure device on a protective glass 10;

FIG. 6A: shows the detailed view of the analysis device of FIG. 3A, wherein a movable flap or sliding element is additionally arranged within the processing chamber;

FIG. 6B: shows the embodiment of FIG. 6A as a detailed view in a horizontal cross section;

FIG. 7A shows a further embodiment of the analysis device, in which the protective glass is analyzed by a plurality of independent sensor devices;

FIG. 7B shows the embodiment of FIG. 7A as a detailed view in a horizontal cross section;

FIG. 8A shows a further embodiment of the analysis device, in which the sensor device is arranged coaxially to the protective glass;

FIG. 8B shows the embodiment of FIG. 8A as a detailed view in a horizontal cross section;

FIG. 8C shows an advantageous development of an embodiment;

FIG. 9A shows a further embodiment of the analysis device, in which an additional mirror element is arranged in the analysis device for the coaxial analysis of the protective glass;

FIG. 9B shows the embodiment of FIG. 9A as a detailed view in a horizontal cross section;

FIGS. show further implementations; 10A-10C

### DETAILED DESCRIPTION OF PREFERRED EMBODIMENTS

Exemplary embodiments of the present invention are described in detail below on the basis of exemplary figures. The features of the exemplary embodiments can be combined in whole or in part and the present invention is not restricted to the described exemplary embodiments.

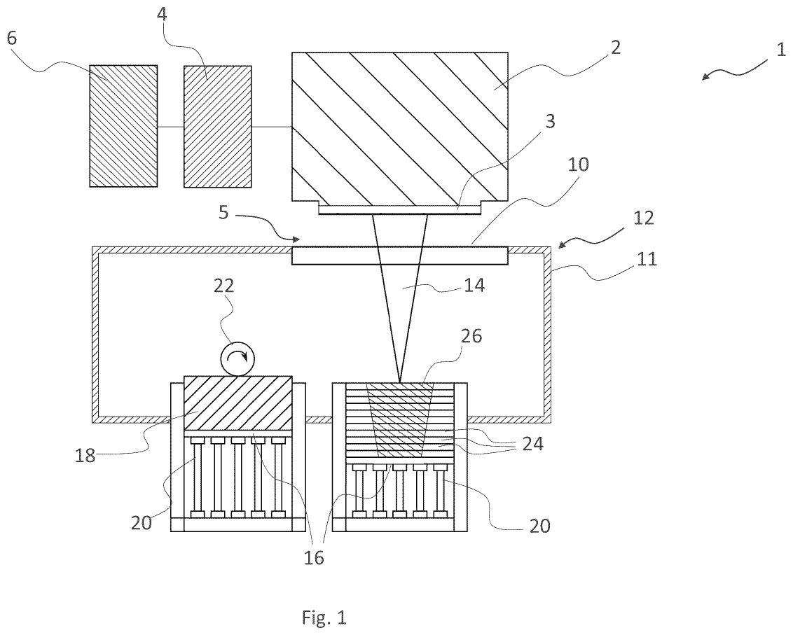

FIG. 1 shows a schematic embodiment of a manufacturing system 1 based on optical interactions, specifically a manufacturing system for selective laser melting, in which a material 18 to be processed is applied in layers to a movable base plate 16 and is locally remelted by means of focused laser irradiation such that a three-dimensional workpiece 26 can be generated by continuous application, exposure and melting of further material layers 24 (additive manufacturing).

For this purpose, the manufacturing system 1 provides at least one (laser) light source 4 which generates a light beam modified for interaction with the material layers 24 via a control system 6 coupled to the manufacturing system 1, and this light beam is focused via a light path 14 onto the material layer to be processed with the aid of various optical elements integrated in a scanning head 2, such as for example focusing or scattering lenses, mirrors, optical filters etc. In this case, the scanning head 2 itself is present as an independent, rigidly configured housing in which the latter optical elements are likewise oriented so as to be controllable manually and/or in an automated manner and thus generate a three-dimensionally positionable light path 14 depending on their current orientation and the optical properties ascribed to them (e.g. focusing lengths or filter frequencies).

In order additionally to ensure suitable protection of above-described optical elements against any process emissions, the scanning head 2 in the present embodiment is firstly configured as a closed or closable system in which the light path 14 can be guided out of the scanning head 2 only through an exit hole provided with a scanning head glass 3. In further embodiments, however, it may also be possible to configure the optical elements as a freestanding device system or to integrate the latter at least partially in other units of the manufacturing system 1, such as for example the light source 4. In this case, the representation of the light source 4 also serves only for visual purposes, such that the latter can likewise be configured so as to be integrated in the scanning head 2 or other elements of the manufacturing system 1.

Due to the above-mentioned working distances of the optical elements implemented in the scanning head 2, the light path 14 used for manufacturing the workpiece 26 furthermore leads through the scanning head glass 3 into a processing chamber 12 spaced apart from the scanning head 2 by a free space 5, in which the various material layers 24 to be processed are applied to a movable base plate 16 and are focused by the finishing light beam for producing the workpiece 26. In this case, the precise manufacturing process provides, as described above, an iterative coating and exposure process: in order to produce any desired three-dimensional workpiece 26, the material to be processed is firstly applied in powder form in a thin layer 24 to a base plate 16 and is positioned by at least vertical movement of the base plate 16 by means of controllable lifting devices 20 (e.g. pneumatic, electrical or mechanical cylinder or scissor lifting devices) to a processing height corresponding to the light path 14. In order in this case to ensure a material layer 24 which is as uniform and in particular as dense as possible, the corresponding pulverulent material 18 in this exemplary embodiment is additionally compressed beforehand with at least one roller 22 moving in parallel with the material layer 24 to be processed (alternatively with further devices such as for example integrated silicone lips), brought to a predefined layer height and excess material 18 removed from the base plate 16, such that in particular constant material conditions can be ensured within each iteration process.

The processed pulverulent material layer 24 is then locally remelted by means of the above-mentioned light beam focused by the light path 14 and forms a solid material layer after solidification. Subsequently, the base plate 16 is lowered by a predefined layer thickness of the material layer 24 and a renewed material layer 24 is applied to the base plate 16, such that a fused three-dimensional material form (the workpiece) 26 can be formed by repeated processing and addition of new material layers 24.

In order to enable the atmospheric conditions suitable for the above-mentioned SLM production process, the processing chamber 12 of the production plant 1 is furthermore designed as a completely closable processing housing which is equipped with possible regulation elements, such as for example pressure regulators or valves configured for introducing or exporting required processing chemicals (e.g. argon, neon etc.) and which in particular completely encloses the above-mentioned base plate 16 by integration into the processing chamber structure 11 (i.e. at least the processing chamber outer wall) and can thus provide a production area shielded from external influences. In order additionally to likewise enable the contact of the light path 14 with the different material layers 24, a protective glass 10 is furthermore introduced into the processing chamber housing 11 which, on account of its optical properties, is at least configured both to allow the light beam emanating from the light source 4 or controlled by the scanning head 2 into the processing chamber 12 and to shield the process emissions 28 (powder residues, smoke, sparks etc.) occurring in the scanning head 2 or otherwise attached elements of the production plant 1 from any process emissions occurring during the production.

Accordingly, as already mentioned above, the problem arises in conventional production plants 1 according to the state of the art based on optical interactions that, by virtue of the simultaneous protective and transmission function of the protective glass 10 introduced into the processing chamber 12, the production quality of the production plant 1 can noticeably deteriorate on account of emission particles 28 accumulating on the protective glass 10 (and thus interacting with the light path 14 to be produced). On the other hand, however, in most cases any cleaning and/or replacement processes relating to the protective glass 10 are also associated with unusually high costs and service lives of the production plant 1, such that it is of utmost importance for current production plants 1 to implement a method for identifying any (contamination and/or damage) states and thus to generate an indication as accurate as possible of respectively required maintenance measures. For this purpose, the analysis device D of the present invention is proposed.

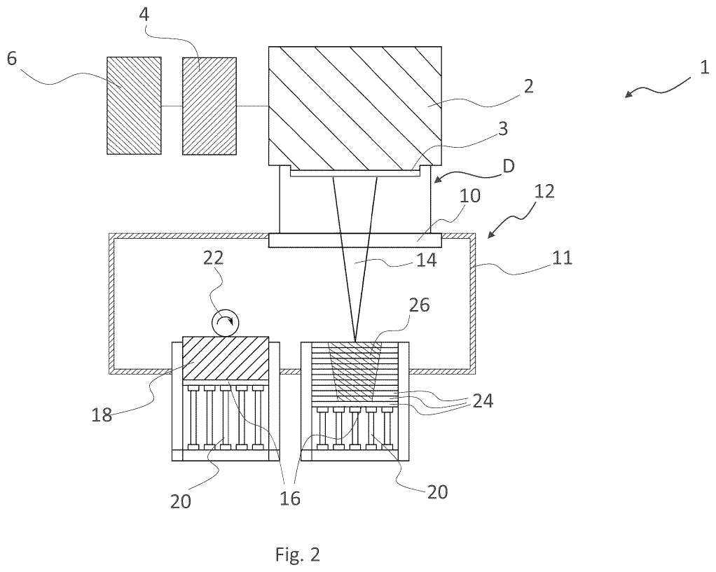

In this regard, FIG. 2 shows a first schematic representation of the manufacturing system of the present invention, in which the analysis device D is represented so as to be integrated in the production plant 1 of FIG. 1. As can be seen, the analysis device D is in this case configured so as to be implemented specifically in the free space 5 caused by the optical properties of the production plant 1, as a result of which the latter is positioned in particular directly along the light path 14 and is preferably detachably connected both to the scanning head 2 and to the processing chamber 12 of the production plant. In this respect, this embodiment of the production system accordingly has the advantage that, by utilizing already existing free spaces within the production plant 1, no further (for example optical) adaptations of the production plant 1 during the implementation of the analysis device D are necessary, as a result of which the analysis device D can thus be integrated extremely simply and efficiently into an existing production process.

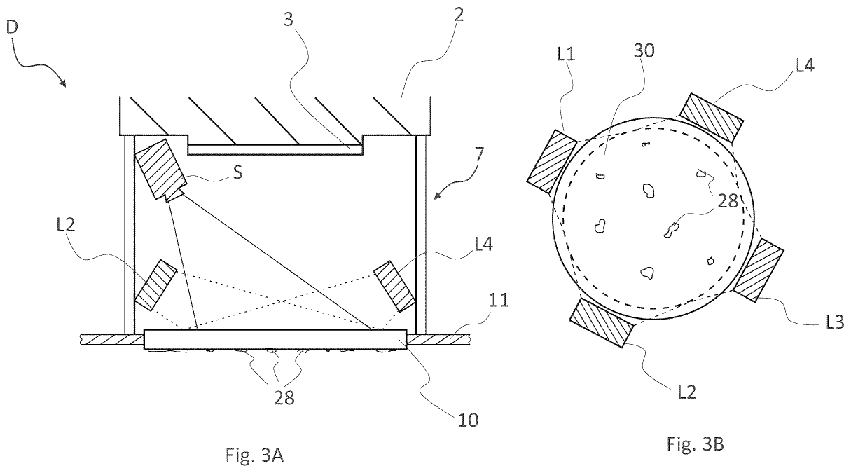

FIGS. 3A and 3B additionally show a schematic detailed representation of a first embodiment of the analysis device D shown in FIG. 2 and integrated into the production plant 1, in each case in a horizontal and a vertical cross section. As mentioned above, the analysis device D is in this case implemented in the free space 5 between the scanning head 2 and the processing chamber 12 and thus claims only unused areas of the production plant 1 for analysing the protective glass state. In this case, the analysis device D itself comprises at least the optical sensor device S, which is configured as an imaging sensor provided with optics (focusing lenses, mirrors, filters, condensers etc.), in arbitrary cases also as an arbitrary camera device, and a plurality of exposure devices L1-L4 for exposing the protective glass 10 to be analysed by the optical sensor device S. In order additionally to shield the above-mentioned device elements of the analysis device D against external influences, such as for example dust or harmful exposures, the optical sensor device S and the exposure devices L1-L4 are additionally arranged in a protective housing 7 of the analysis device D configured for example in the form of a tube, the outer wall of which protective housing is connected both to the scanning head 2 and to the outer processing chamber structure 11 and thus forms a closed system made possible by this connection. Furthermore, as a result of the positioning of the protective housing 7, the outwardly pointing side of the scanning head glass 3 and of the protective glass 10 of the processing chamber 12 is equally integrated into the area enclosed by the analysis device D, as a result of which these elements can also be additionally protected by the implementation of the analysis device D.

The precise positioning of the optical sensor device S and/or of the exposure devices L1-L4 of the analysis device D can additionally vary depending on the construction of the production plant 1 to be analysed, but in the case shown in FIGS. 3A and 3B is at least configured such that the optical sensor device S is arranged above the exposure devices L1-L4, for example on the inner side of the protective housing 7, and thus, on account of a possible positioning outside the light path 14 generated by the light source 2, makes possible a problem-free continuation of possible production processes. The exposure devices L1-L4 used for exposing the protective glass 10 are furthermore, in particular in order to be able to generate a homogeneous exposure area, positioned at uniform intervals, for example symmetrically (see FIG. 3B), within the protective housing 7 and are equally oriented such that the protective glass surface exposed in possible production processes of the production plant 1 is in no way impaired. In this respect, with the implementation of the above-mentioned device elements defined by the analysis device D, in particular a device system can be generated which both makes possible an efficient and extremely precise detection of the protective glass state to be analysed and also, as a result of the interaction-free positioning of the latter elements, allows a simple protective glass assessment to be implemented in each production process.

The assessment process of the protective glass 10 carried out by the analysis device D additionally takes place in the exemplary embodiment shown in FIGS. 3A and 3B by means of evaluation of the incident light recordings generated by the optical sensor device S: the optical elements of the optical sensor device S and of the exposure devices L1-L4 used for focusing and adjusting and/or the general alignment of the latter device elements are firstly oriented such that a specific plane, the object plane 30 (see FIG. 3B), of the protective glass 10 is focused by the optical sensor device S and is exposed with the aid of the exposure devices L1-L4, as a result of which any contamination, damage and/or aging structures 28 (material residues, shives, scratches, bleaching, etc.) collected on the side of the protective glass 10 facing the processing chamber 12 are uniformly illuminated from the outer side of the processing chamber 12 and the scattered light thus generated by the structures can be fed back as a location-dependent signal to the imaging sensor of the optical sensor device S. Accordingly, an at least one-dimensional signal is generated in the optical sensor device S, but in preferred cases in particular a two-dimensional image of the previously focused object plane 30, in which the respective contamination, damage and/or aging structures 28 lying in the object plane and illuminated by the exposure devices L1-L4 are represented as bodies equipped with comparatively high signal or intensity values and can thus be analyzed for continuing state assessments.

The determination of the protective glass state is then effected, as already mentioned above, by evaluation of the information obtained in the generated image, specifically by calculation of a degree of state dependent on a plurality of imaging parameters and describing the quality state of the protective glass 12, which degree of state can be generated in the present invention either manually, e.g. by output and assessment of the image by means of trained technical personnel, or in an automated manner on the basis of an evaluation unit (not shown) implemented in the analysis device D. Suitable examples of the above-mentioned imaging parameters can in this case represent in particular properties related specifically to the recorded structures 28, such as the number, size, shape or density of the contamination, damage and/or aging structures 28 situated along the object plane 30 (and thus along the protective glass 10), but also characteristic variables based on optical influences, such as the intensity values associated with the structures 28 within the image generated or to be analyzed, and can thus allow the assessment of the protective glass state in particular as a function of direct factors associated with the contamination or damage.

In order to determine the above-described properties, the evaluation unit of the analysis device D is additionally equipped with a series of image analysis and processing programs, which allows the evaluation unit to identify individual structure bodies within the generated image by way of example via different pixel segmentation and assessment processes and to extract the desired parameters therefrom. Furthermore, in order to improve the identification of any structures, the evaluation unit can previously adapt the image to be analyzed with a plurality of preparation mechanisms, for example background corrections, edge filtering and/or blurring corrections, or convert the former, for example by forming the previously described difference image, into a different image format, as a result of which the analysis of the protective glass 10 can be made even more precise.

In a last step, the evaluation unit is additionally configured to convert the above-mentioned imaging parameters into an easily comprehensible degree of state, for example a percentage decreasing with the nature of the protective glass 10, a normative quality statement (e.g. “protective glass clean”, “protective glass damaged”, “protective glass contaminated”) or a proposed treatment step (“cleaning necessary”, “replacement necessary”, etc.), so that, by outputting the degree of state by the analysis device D, a selected specialist personnel can be quickly and effectively informed about protective glass processing steps to be carried out. In the case of the above-mentioned statements or proposed treatment steps, this can be done via the comparison of the identified imaging parameters with any limit values adapted to the parameters, so that the evaluation unit outputs a request for cleaning or for replacing the respective protective glass 10, for example after a specific number, density or sizes of identified damage, soiling and/or aging structures have been exceeded. In the case of a plurality of imaging parameters to be integrated for the calculation of the degree of state, the former can additionally initially also be combined via a previous combination step, for example by weighted and/or previously relativised averaging processes, so that it is likewise possible in the present invention to include different parameters to be identified in the generated image for determining the protective glass state.

Accordingly, by means of the embodiment of the analysis device D represented in FIGS. 3A and 3B, an integratable protective glass examination unit is provided, which can both be introduced simply and extremely efficiently into existing production plants 1 and can determine the current state of the protective glass 10 to be correspondingly analyzed by including primary parameters, i.e. parameters existing explicitly on the protective glass 10.

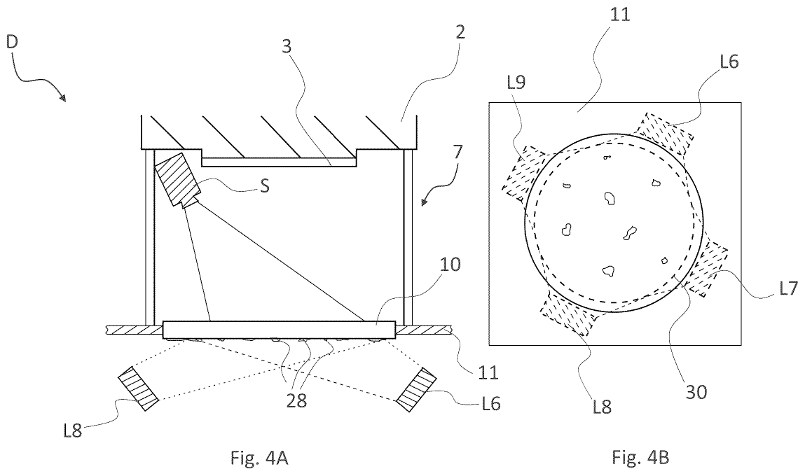

Moreover, FIGS. 4A and 4C show a further embodiment of the previously described analysis device D, in which, instead of the incident light illumination used in FIGS. 3A and 3B, transmitted light illumination implemented for identifying any soiling, damage and/or aging structures 28 is formed. Compared to the previously described embodiment, the analysis device D of these figures therefore differs in particular by the positions of the exposure devices L6-L9 used for illuminating the protective glass 10, which in this example have been attached within the processing chamber 12 and therefore on the other side of the protective glass 10 compared to the optical sensor device S.

In this respect, the exposure devices L6-L9 of this exemplary embodiment are configured to illuminate the protective glass 10 in particular from the wetted/contaminated side in order to detect the particles 28 located on the protective glass 10 by the optical sensor device S, as a result of which a large part of the light emanating from the exposure devices L6-L9 likewise passes through the protective glass 10 into the beam path of the optical sensor device S and is only reflected or scattered at points afflicted with particles 28. Accordingly, an image contrary to the previous embodiment results in this case within the image generated by the optical sensor device S, in which uninfluenced portions of the detected protective glass 10 are represented as a signal-or intensity-strong background, but positions associated with respective contamination, damage and/or aging structures 28 are represented as low-signal bodies. Consequently, the state of the protective glass 10 to be analyzed can also be effectively determined in this exemplary embodiment by the already previously mentioned calculation of the degree of state, since the analysis device D likewise implements a spatially resolved representation of any soiling, damage and/or aging structures 28 in this case.

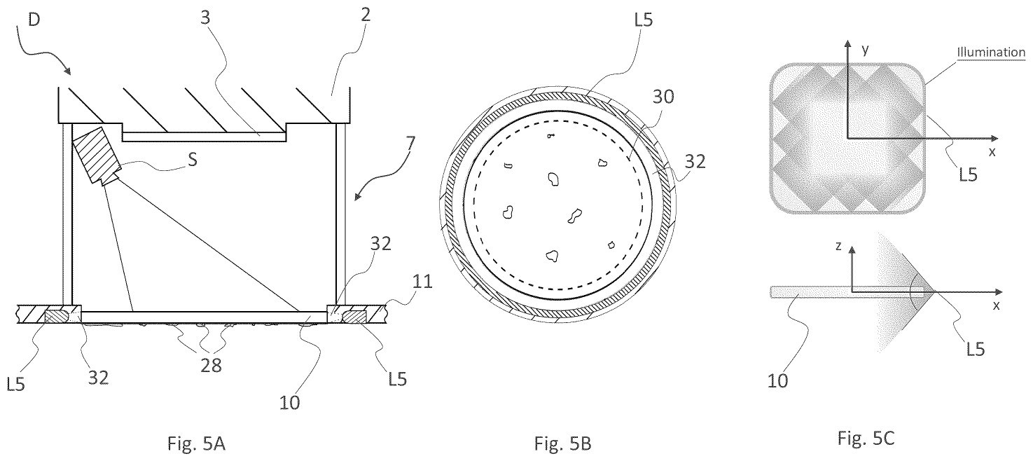

FIGS. 5A to 5C show an embodiment of the present analysis device D, in which the exposure device L5 is equipped with LEDs, and wherein the analysis device is integrated into the processing chamber housing 11, for example, and therefore allows the protective glass 10 to be exposed uniformly, in particular radially inward from the outside of the protective glass, by an exposure beam 32 (or a plurality of exposure beams) oriented parallel to the protective glass 10 . The exposure device L5 is formed as an integrated illumination ring or LED illumination ring (which laterally preferably completely encloses the protective glass) around the protective glass 10 equally represented as circular. In other embodiments, however, the exposure device L5 can also be present in other geometries adapted in particular to the structure of the protective glass 10.

Particularly advantageously, as shown in FIG. 5C, the protective glass 10 is configured as a rectangle or square with rounded corners, since lateral illumination by the exposure device L5 thereby achieves particularly good illumination, in particular in the corner regions. The exposure device is arranged here as an LED chain around the protective glass 10. In the side view in FIG. 5C, the emission direction and the preferred emission angle of the LEDs of the exposure device are additionally represented. The emission angle is for example below 80°, wherein the LEDs are oriented toward the center of the protective glass. Particularly preferably, the emission wavelength of the LEDs is selected here in the range of 520-522 nm, with a half-width of 32 nm. The deviations on the protective glass can be detected particularly well by this particular embodiment.

In this respect, such an embodiment of the exposure device L 5 integrated into the production plant 1 results in the advantages that the latter device element can be introduced in particular extremely efficiently and in a space-saving manner within the production system, whereas the above-mentioned type of exposure equally allows an assessment of the protective glass according to the above-mentioned image analysis and state degree calculation process. Furthermore, the positive effect results that, as a result of the lateral exposure of the protective glass 10 (lateral scattering of light into the protective glass, in particular LEDs arranged in an annular manner), both the side of the protective glass 10 facing the processing chamber 12 and the analysis device D is illuminated from the inside, as a result of which any error-generating processes, such as for example back reflections, on the protective glass outer sides can be effectively prevented.

Optionally, the sensitivity of the camera sensors (in particular of the optical sensor device S) to relevant wavelengths can be restricted by connecting suitable filters (in particular bandpass filters with a central wavelength of 525 nm; half-width ±80 nm). The camera sensor can advantageously have the following properties: progressive scan CMOS; global shutter; peak quantum efficiency around 500 nm.

An advantageous exposure device L5 is therefore designed such that a plurality of LEDs are arranged on the circumference of the protective glass (in particular symmetrically). The analysis device D (or device) can optionally also be designed without a sensor S, such that a check of the protective glass 10 is effected manually. The exposed object plane can therefore be assessed by manual, direct optical detection (e.g. by the system operator). Alternatively or additionally, the exposure device L5 advantageously comprises a green laser for exposing the object plane of the protective glass 10 in order to make damage and/or dirt highly visible to the human eye.

In a method for producing a component by additive manufacturing by means of the described device, the step “checking the protective glass for damage” can be comprised in the preparation and downstream checking of the construction job. For this purpose, the protective glass 10 is exposed on multiple sides by means of the exposure device L5, with an emission wavelength in the range of 520-522 nm. This makes possible accurate detection of the exposed object plane. Particularly advantageous homogeneous illumination can be achieved by this method, so that in particular contamination and damage states of the protective glass can be determined effectively and accurately. Uniform illumination without shadow formation and with uniformly intense luminosity is achieved. In particular for additive manufacturing by means of laser powder bed fusion (selective laser melting), the cleanliness of the surfaces of the protective glass 10 can be ensured by suitable cleaning. This can be carried out not only during preparation, but e.g. also after each construction job as a quality assurance measure.

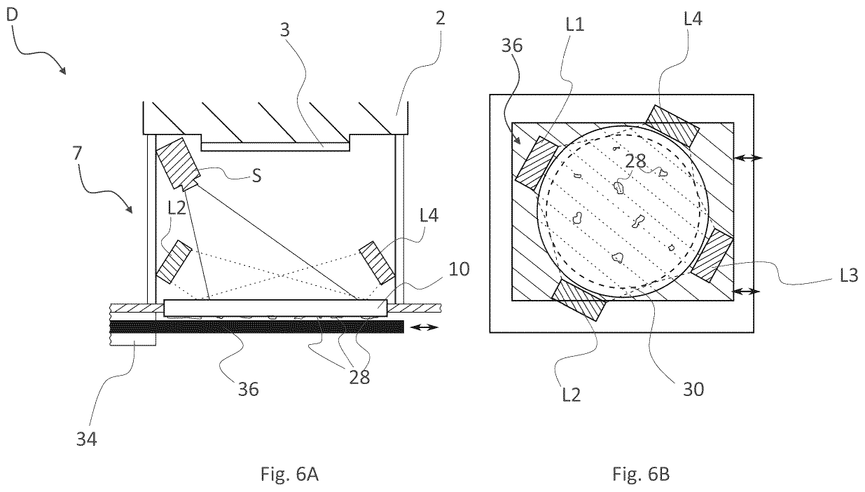

FIGS. 6A and 6B additionally again show the embodiment of the analysis device D represented in FIGS. 3A and 3B, in which, in addition to the exposure devices L1-L4 and the optical sensor device S, a flap or sliding element 36 movable along the longitudinal axis of the protective glass 10, represented here as a black-anodized and thus reflection-free plate, has been inserted into the processing chamber 12. The flap or sliding element 36 in this case comprises in particular a controllable movement mechanism 34 (e.g. a pneumatic, electrical or mechanical motor element) coupled to the manufacturing process of the manufacturing system 1, which allows the flap or sliding element 36 to move parallel to the alignment of the protective glass 10 at least from a first position for shielding the protective glass 10 from any exposure sources located in the processing chamber 12 to a second position for re-releasing the light path 14 between the scanning head 2 and the processing chamber 12 and back. Accordingly, by the flap or sliding element 36 thus additionally implemented in the manufacturing system 1 in the first position, any exposure originating from the processing chamber 12 and likewise penetrating into the analysis device D can be suppressed, which, specifically for the imaging detection of the previously mentioned object plane 30 by the optical sensor device S, efficiently blocks possible interfering background signals and thus implements far more consistent framework conditions for the above-mentioned recordings. In this respect, the protective glass evaluation process carried out by the analysis device D in the embodiment shown in FIGS. 6A and 6B also provides at least additionally to move the flap or sliding element 36 into the first position whenever the protective glass 10 is to be examined by the analysis device D, and to return the flap or sliding element into the second position if the light path 14 defined by the protective glass 10, for example for manufacturing a workpiece 26 by the manufacturing system 1, should be left free. As a result, an improvement of the protective glass analysis process can also be made possible in this case without having to modify and/or adjust already existing manufacturing mechanisms of the previously mentioned manufacturing system 1.

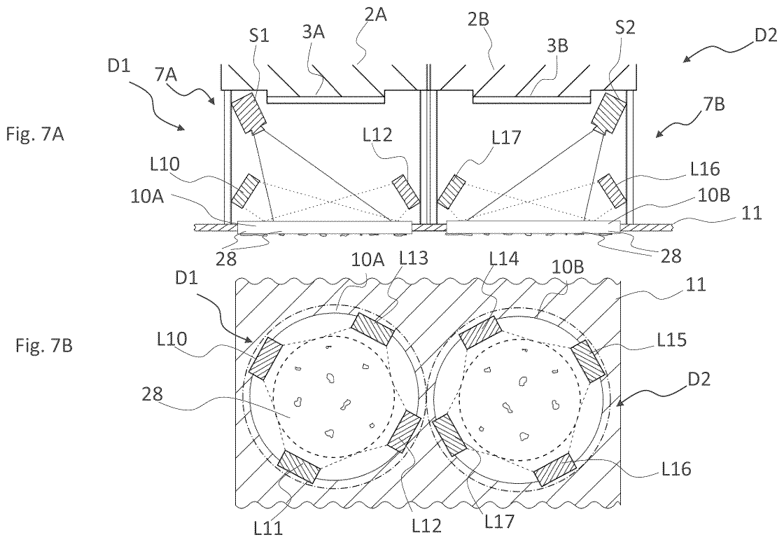

FIGS. 7A and 7B additionally show a further detailed representation of an embodiment of the claimed manufacturing system, in which the present manufacturing system 1, in comparison with the previous exemplary embodiments, is equipped with a plurality of scanning heads 2A & 2B and protective glasses 10A & 10B and is consequently capable of processing one or a plurality of workpieces 26 to be manufactured by means of light paths 14 preferably controllable independently of one another. In order to correspondingly also make possible as accurate as possible detection and evaluation of the introduced protective glasses 10A & 10B in such multi-scanner systems, in the present embodiment a plurality (in this case two) of analysis devices D1 & D2 adapted to the number of protective glasses 10A & 10B are equally introduced into the manufacturing system 1, so that each of the implemented protective glasses 10A & 10B can preferably be individually analyzed and checked for improving any manufacturing processes. For this purpose, the analysis devices D1 & D2 themselves are positioned in FIGS. 7A and 7B, analogously to the previous exemplary embodiments, between one of the respective scanning heads 2A & 2B and one of the protective glasses 10A & 10B shown and have, as also in the embodiment already shown for example in FIGS. 3A and 3B, in each case a plurality of exposure devices L10-L17 and at least one sensor device S1 & S2, in order to precisely expose any contamination, damage and/or ageing structures 28 occurring on the protective glasses 10A & 10B assigned to them and to be able to detect and analyze them by the detection mechanisms already mentioned above. Furthermore, the analysis devices D1 & D2 are in this case equally each equipped with a protective housing 7A & 7B formed at least laterally of the above-mentioned device elements and separating the inner space of the analysis device D1 & D2, which protect the latter both individually against any process emissions occurring (dust particles, smoke etc.) and can also keep existing protective glass analysis conditions constant, for example by blocking certain background irradiations also generated by the respectively other analysis device D1 & D2.

Accordingly, it is apparent from the exemplary embodiment shown that the present invention can also be optimally used in a manufacturing system embossed by a plurality of scanning heads 2A & 2B, protective glasses 10A & 10B or further devices required for workpiece manufacturing, in particular in which a plurality of individually acting and independently positionable analysis devices D1 & D2 can be integrated at least to the same extent for this purpose. In this respect, the above-mentioned embodiment specifically results in the advantage that each protective glass 10A & 10B implemented in the manufacturing system 1 can also be analyzed by an analysis device D1 & D2 oriented solely on this protective glass 10A & 10B and can be assessed further, whereby an extremely precise state detection is made possible.

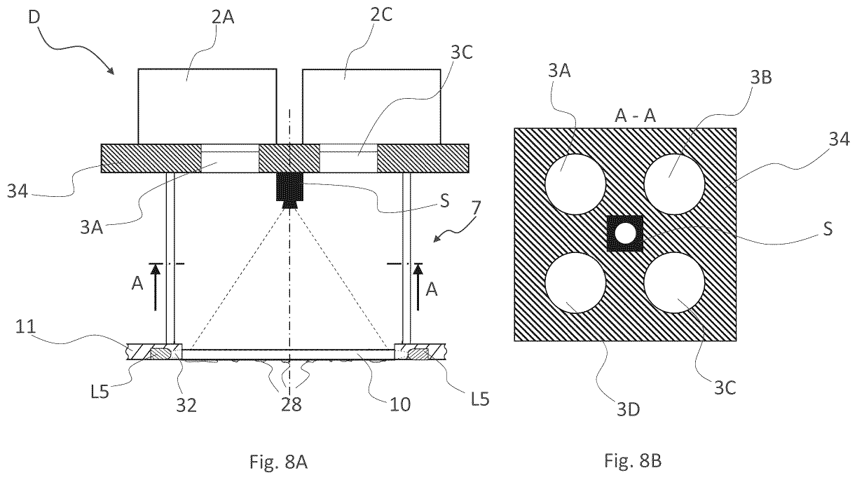

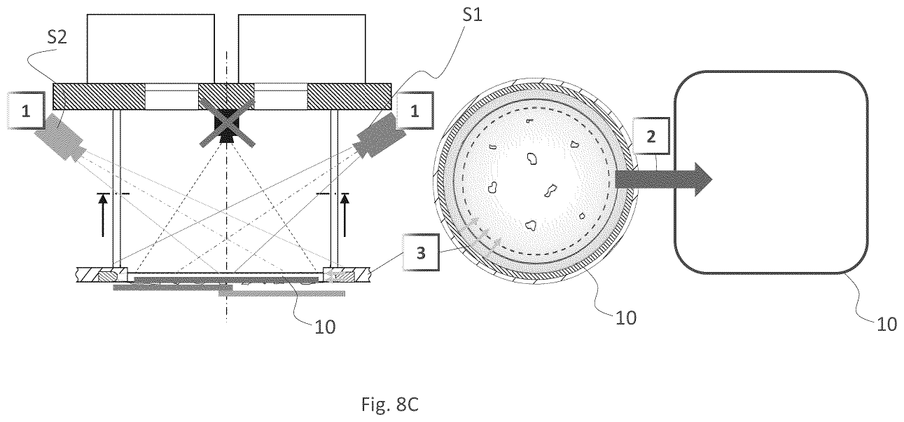

FIGS. 8A and 8B additionally show a further embodiment of the claimed analysis devices D, in which the production plant 1 is equipped analogously with a plurality of scanning heads 2A-2C and with scanning head glasses 3A-3C connected thereto and required for forwarding the light beam 14 emanating from the scanning heads 2A-2C and the analysis device 1 has an exposure device L5 according to the embodiment of FIGS. 5A and 5B. The scanning head glasses 3A-3C themselves are in this case introduced into an independent base plate 34 (at least thermally) decoupled from the analysis device D and/or the scanning heads 2A-2C, which in particular makes it possible to prevent any displacements/displacements of the scanning heads 2A-2C or of the device elements of the analysis device D on account of expansions within the manufacturing system 1 which arise during the manufacturing and are based at least on thermal fluctuations, whereby a continuously accurate and thus error-prone processing or analysis process can be ensured.

FIG. 8B furthermore shows a schematic plan view of the inner side of the previously described base plate 34 represented along the plane of view A. In this case, the scanning head glasses 3A-3C are represented as circular, but in further cases also installations identifiable by other geometries and having possible optical properties (e.g. wavelength-specific absorptions/reflections), which are positioned concentrically at predefined intervals, preferably for example about a predefined point, and thus enable processing of the workpiece 26 to be manufactured by a plurality of light beams or light paths to be distinguished. In the center of the represented concentrically arranged scanning head glasses 3A-3C, the sensor device S is additionally attached in this case, which, on account of its mentioned central positioning preferably oriented equally with respect to the protective glass 10, both generates a maximum detection area and, on account of the attachment between protective glass 10 and the scanning heads 2A-2C shown again in FIG. 8A, can implement an extremely space-saving integration. Furthermore, this arrangement makes it possible to orient the sensor device S in particular also coaxially to the respectively present protective glass 10 (e.g. longitudinal axis of the sensor device S is parallel to at least one longitudinal axis of the protective glass 10), such that the image plane to be detected can already coincide by suitable mechanical orientation of the sensor device S with the protective glass surface having damage, contamination and/or aging structures 28 (in particular the inner side of the protective glass 10 present in the process chamber 12). Accordingly, the above-mentioned arrangement of the sensor device S and the exposure device L5 primarily generates an embodiment of the analysis device D, which not only implements a positioning of the respective device elements that is as space-saving as possible, but equally also enables an optically preferred orientation of the optical sensor device S.

In FIG. 8C, a further advantageous embodiment is represented. In this case, the simple sensor device S is replaced by two sensor devices S1 and S2 spaced apart from one another and preferably oriented (and arranged opposite one another). The first sensor device S1 is in this case oriented toward a first section of the protective glass 10 and the second sensor device S2 is oriented toward a second section. These sections can also overlap. The detection range can be optimised by this arrangement and the accuracy of the detection can be further improved, in particular in combination with the mentioned exposure device which, as represented, emits directly into the protective glass. The protective glass 10 can in this case preferably be circular or rectangular with rounded edges. In this case, the LED exposure device L5 encloses the protective glass 10.

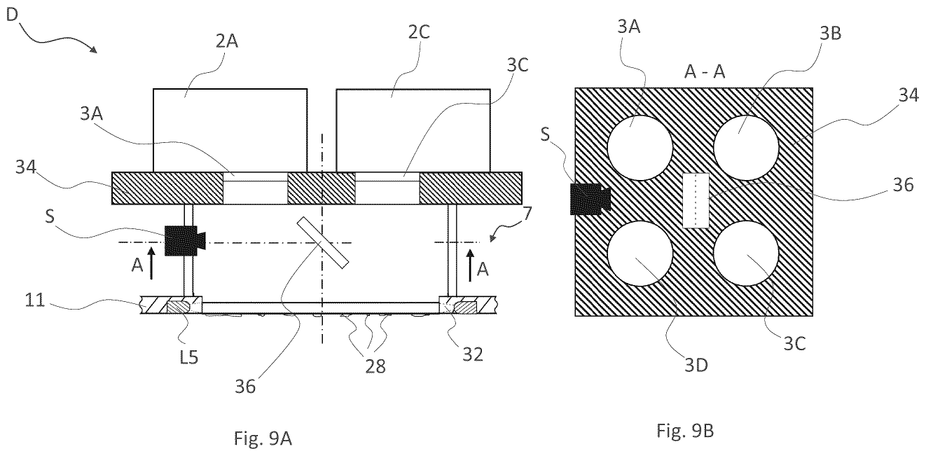

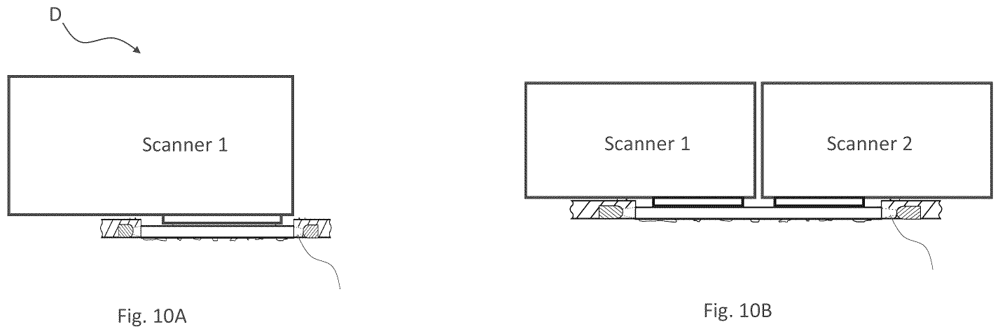

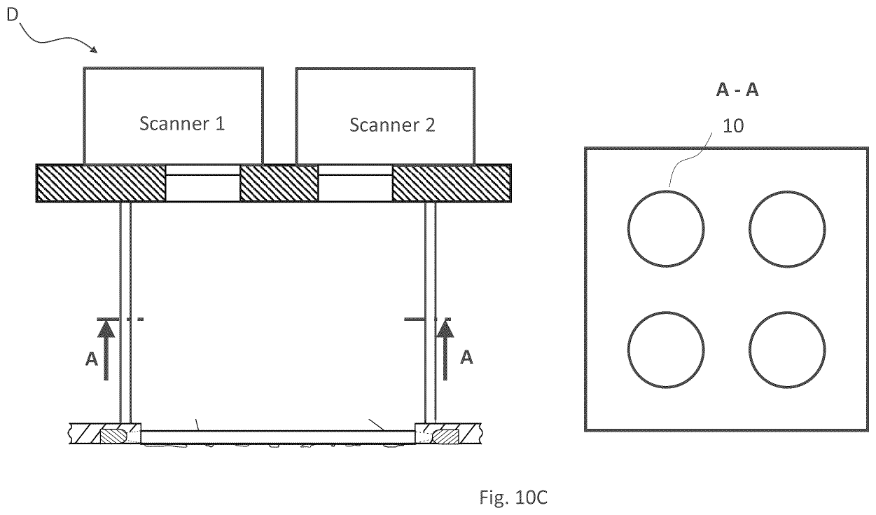

Optionally, the previously mentioned coaxial orientation of the sensor device S can additionally also be implemented by additional optical elements, such as for instance a fully or semi-transparent mirror. For this purpose, FIGS. 9A and 9B show by way of example a further variant of the analysis device D, based on the embodiment of FIGS. 8A and 8B, in which the sensor device S, counter to the abovementioned central positioning, is introduced laterally, for example into the structure of the protective housing 7, and the scattering and reflection radiations emanating from the structures 28 of the protective glass 10 to be detected can be received coaxially via a further mirror device 36 additionally attached in the analysis device D. The advantage of the embodiment represented here can in this case be seen in particular in the extremely space-saving introduction of the required device elements, since the sensor device S, although still optically coaxially connected to the protective glass 10, can potentially be integrated at any desired position within the analysis device D by the additional implementation of the mirror device 36, such that the analysis device D can also be installed in particularly small installation spaces. Furthermore, it can preferably also be possible to design the mirror device 36 in particular to be controllable such that its orientation can at any time be dynamically adapted to the current position or arrangement of a selected sensor device S, such that with the aid of the first-mentioned device not only the position of the corresponding sensor device S varies freely selectably within the analysis device D, but equally also a plurality of sensor devices S can be used by means of the mirror device 36.

Further possible embodiments are represented in FIGS. 10A to 10C. In FIG. 10A, the scanner (scanning head 2) is arranged in direct proximity or directly on the protective glass. However, the device can also be designed such that more than one scanning head is arranged on the protective glass 10, as is represented for example in FIG. 10B. In FIG. 10C, an element is represented which has a plurality (here four) of circular protective glasses which are each assigned to at least one scanning head. These protective glasses can be correspondingly exposed via the exposure device L5.

1. Manufacturing system for manufacturing a workpiece by exposing powder material and/or a workpiece element, wherein the manufacturing system comprises:
at least one light source for irradiating the powder material and/or workpiece element provided in a processing chamber;
a light path generated by the light source which extends through a protective glass into the processing chamber of the manufacturing system, wherein the protective glass is provided for protection against damage and/or contamination; and
at least one exposure device for exposing an object plane associated with the protective glass of the manufacturing system,
wherein the exposure device encloses the protective glass at least partially, preferably completely, and comprises a plurality of light-emitting diodes, LEDs.

2. Manufacturing system according to claim 1, wherein the LEDs are arranged laterally on the protective glass for direct exposure of the object plane.

3. Manufacturing system according claim 1, wherein the exposure device comprises LED strips with integrated diffusers and/or wherein a diffuser is arranged between LED strips and a side surface of the protective glass.

4. Manufacturing system according claim 1, wherein the emission wavelength of at least some of the LEDs is in the range of 520-522 nm with a preferred maximum half-width of 32 nm; and/or wherein colored LEDs are arranged such that the light for exposing the object plane is green and/or wherein LEDs with white light are provided.

5. Manufacturing system according claim 1, wherein the emission angle of the LEDs is 120° or 180° or is in a range of 120° to 180°.

6. Manufacturing system according to at least one of the preceding claims, wherein the same number of LEDs is arranged on each side surface of the protective glass for homogeneous exposure of the object plane.

7. Manufacturing system according to claim 1, wherein the manufacturing system has a camera sensor for detecting the object plane and the camera sensor has the highest quantum efficiency in the range of the wavelength of 520-522 nm and the LEDs of the exposure device are configured to emit light with a wavelength of 520 nm; and/or wherein the camera sensor has the highest quantum efficiency in the range of green light.

8. Manufacturing system according claim 1, wherein the maximum of the quantum efficiency of the camera sensor corresponds to the emission wavelength of the LEDs and is preferably at 520 nm.

9. Manufacturing system according to claim 1, wherein a bandpass filter is attached in front of the camera lens, which bandpass filter is adapted to the emission wavelength of the LEDs in order to filter external light sources,

10. Manufacturing system according to claim 1, wherein the exposure device comprises LEDs arranged uniformly on a printed circuit board, with a distance between adjacent LEDs of up to 20 mm, at a power consumption of 11.7 W/m.

11. Manufacturing system according to claim 1, wherein a fluctuation in the light intensity of the LEDs does not exceed a value of +/−15%, and particularly preferably +/−10%, by a predetermined value.

12. Manufacturing system according to claim 1, wherein the illumination is operated with a constant voltage of 24 V.

13. Manufacturing system according to claim 1, wherein the predetermined value of the luminous flux of the LEDs is in the range of 1000 to 1400 lm/m, and/or wherein the LEDs are formed as chip-on-board LEDs (COB LEDs) without lens part.

14. Method for determining a state, in particular a soiling and/or damage state, of a protective glass of a manufacturing system based on optical interactions according to claim 1, wherein the method comprises:
exposing the object plane by the exposure device detecting light intensity values of the object plane of the protective glass by a camera sensor and analysing the detected light intensity values for identifying damage and/or contamination, and/or
visually checking the protective glass by a system operator, with the exposure device activated for detecting damage and/or contamination of the protective glass.

15. Method according to claim 14, comprising the step of detecting an object plane associated with the protective glass of the manufacturing system by the camera sensor with simultaneous exposure of the object plane by the exposure device; and/or
wherein the object plane to be detected is divided into a plurality of evaluation regions and the individual evaluation regions are evaluated independently for determining the degree of damage or contamination of the protective glass.
